(19) United States
(12) Patent Application Publication
(10) Pub. No.: US 2024/0346352 A1
(43) Pub. Date: Oct. 17, 2024

(54) DYNAMICALLY RECONFIGURABLE ARCHITECTURES FOR QUANTUM INFORMATION AND SIMULATION

(71) Applicants: President and Fellows of Harvard College, Cambridge, MA (US); Massachusetts Institute of Technology, Cambridge, MA (US)

(72) Inventors: Dolev Bluvstein, Cambridge, MA (US); Harry Jay Levne, Cambridge, MA (US); Giulia Semeghini, Cambridge, MA (US); Tout WANG, Cambridge, MA (US); Sepehr Ebadi, Cambridge, MA (US); Alexander Keesling Contreras, Cambridge, MA (US); Mikhail D. Lukin, Cambridge, MA (US); Markus Greiner, Cambridge, MA (US); Vladan Vuletic, Cambridge, MA (US)

(21) Appl. No.: 18/294,259

(22) PCT Filed: Aug. 2, 2022
(86) PCT No.: PCT/US22/39189

§ 371 Date: Feb. 1, 2024

Related U.S. Application Data
(60) Provisional application No. 63/228,940, filed on Aug. 3, 2021.

(51) Int. Cl. G06N 10/40; G06N 10/20; G06N 10/70

(52) U.S. Cl. CPC G06N 10/40; G06N 10/20; G06N 10/70

(57) ABSTRACT

Dynamically reconfigurable architectures for quantum information and simulation are provided. A plurality of neutral atoms is provided. Each neutral atom is disposed in a corresponding optical trap. Each of the plurality of neutral atoms is prepared in a m_{F}=0 clock state. A pair of neutral atoms of the plurality of neutral atoms is entangled by directing a laser pulse thereto. The laser pulse is configured to transition the pair of neutral atoms through a Rydberg state. The optical trap corresponding to at least one neutral atom of the pair is adiabatically moved, thereby moving one atom of the pair relative to the other atom of the pair without destroying entanglement of the pair.

### CROSS-REFERENCE TO RELATED APPLICATIONS

This application claims the benefit of U.S. Provisional Application No. 63/228,940, filed Aug. 3, 2021, which is hereby incorporated by reference in its entirety.

### STATEMENT REGARDING FEDERALLY SPONSORED RESEARCH OR DEVELOPMENT

This invention was made with government support under 1745303, 1734011, 2012023 awarded by National Science Foundation, and under W911NF2010021 and W911NF2010082 awarded by U.S. Army Research Office, and under N00014-15-1-2846 and N00014-15-1-2761 awarded by U.S. Office of Naval Research, and under DE-SC0021013 awarded by U.S. Department of Energy. The government has certain rights in the invention.

### BACKGROUND

Embodiments of the present disclosure relate to quantum computation, and more specifically, to dynamically reconfigurable architectures for quantum information and simulation.

### BRIEF SUMMARY

According to embodiments of the present disclosure, methods of quantum computation are provided. A plurality of neutral atoms is provided. Each of the plurality of neutral atoms is disposed in a corresponding optical trap. Each of the plurality of neutral atoms is prepared in a m_{F}=0 clock state. A pair of neutral atoms of the plurality of neutral atoms is entangled by directing a laser pulse thereto. The laser pulse is configured to transition the pair of neutral atoms through a Rydberg state. The optical trap corresponding to at least one neutral atom of the pair is adiabatically moved and a Raman pulse is applied to the at least one neutral atom during said moving, thereby moving the neutral atoms of the pair relative to each other without destroying entanglement of the pair.

In various embodiments, the Raman pulse is applied at a midpoint of said moving. In various embodiments, the adiabatic movement has a constant jerk. In various embodiments, the adiabatic movement has an average speed less than 0.55 μm/μs.

In various embodiments, the optical trap corresponding to the at least one neutral atom is moved to within a blockade radius of a target neutral atom of the plurality of neutral atoms. In various embodiments, the at least one neutral atom is entangled with the target neutral atom. In various embodiments, a gate is applied to the at least one neutral atom and the target neutral atom.

In various embodiments, the plurality of neutral atoms forms a two-dimensional array. In various embodiments, the at least one neutral atom and the target neutral atom are non-adjacent within the two-dimensional array prior to said moving.

In various embodiments, the optical trap corresponding to the at least one neutral atom is generated by directing a beam of light to at least one acousto-optic deflector (AOD) and wherein adiabatically moving the optical trap corresponding to at least one neutral atom comprises varying a drive frequency of the at least one AOD. In various embodiments, at least a first subset of the optical traps corresponding to the plurality of neutral atoms is generated by directing a beam of light to a spatial light modulator (SLM).

According to embodiments of the present disclosure, methods of quantum computation are provided. A plurality of neutral atoms is provided. Each of the plurality of neutral atoms is disposed in a corresponding optical trap. Each of the plurality of neutral atoms is prepared in a m_{F}=0 clock state. A pair of neutral atoms of the plurality of neutral atoms is entangled by directing a laser pulse thereto, the laser pulse configured to transition the pair of neutral atoms through a Rydberg state. The optical trap corresponding to at least one neutral atom of the pair is adiabatically moved, thereby moving the neutral atoms of the pair relative to each other without destroying entanglement of the pair. A first region is illuminated, the first region containing therein a first atom of the pair, thereby applying a rotation to the first atom of the pair. The optical trap corresponding to the first atom of the pair is adiabatically moved out of the first region. The optical trap corresponding to a second atom of the pair is adiabatically moved into the first region. The first region is illuminated, thereby applying a rotation to the second atom of the pair.

In various embodiments, a Raman pulse is applied to the at least one neutral atom during said moving. In various embodiments, the Raman pulse is applied at a midpoint of said moving.

In various embodiments, the adiabatic movement has a constant jerk. In various embodiments, the adiabatic movement has an average speed less than 0.55 μm/μs.

In various embodiments, the plurality of neutral atoms forms a two-dimensional array.

In various embodiments, the optical trap corresponding to the at least one neutral atom is generated by directing a beam of light to at least one acousto-optic deflector (AOD) and wherein adiabatically moving the optical trap corresponding to at least one neutral atom comprises varying a drive frequency of the at least one AOD. In various embodiments, at least a first subset of the optical traps corresponding to the plurality of neutral atoms is generated by directing a beam of light to a spatial light modulator (SLM).

According to embodiments of the present disclosure, methods of quantum computation are provided. A plurality of neutral atoms is provided. Each of the plurality of neutral atoms is disposed in a corresponding optical trap. The plurality of neutral atoms comprises a first subset and a second subset. Each neutral atom of the first subset is placed within a blockade radius of a first corresponding neutral atom of the second subset, thereby forming a first plurality of pairs. Each of the plurality of neutral atoms is prepared in a m_{F}=0 clock state. A first gate is applied to each of the first plurality of pairs. The optical traps corresponding to the first subset are adiabatically moved such that each neutral atom of the first subset is within the blockade radius of a second corresponding neutral atom of the second subset, thereby forming a second plurality of pairs. A Raman pulse is applied to the first subset during said moving. A second gate is applied to each of the second plurality of pairs.

In various embodiments, the first and/or second gate is a CZ gate.

In various embodiments, the optical traps corresponding to the first subset are adiabatically moved to an imaging region not including the second subset. The imaging region is illuminated to measure a state of the first subset.

In various embodiments, the optical traps corresponding to the first subset are moved simultaneously.

In various embodiments, the Raman pulse is applied at a midpoint of said moving.

In various embodiments, the adiabatic movement has a constant jerk. In various embodiments, the adiabatic movement has an average speed less than 0.55 μm/μs.

In various embodiments, the plurality of neutral atoms forms a two-dimensional array.

In various embodiments, the optical trap corresponding to the at least one neutral atom is generated by directing a beam of light to at least one acousto-optic deflector (AOD) and wherein adiabatically moving the optical trap corresponding to at least one neutral atom comprises varying a drive frequency of the at least one AOD. In various embodiments, at least a first subset of the optical traps corresponding to the plurality of neutral atoms is generated by directing a beam of light to a spatial light modulator (SLM).

According to embodiments of the present disclosure, methods of quantum computation are provided. A plurality of neutral atoms is provided. Each of the plurality of neutral atoms is disposed in a corresponding optical trap. Each of the plurality of neutral atoms is prepared in a m_{F}=0 clock state. The plurality of neutral atoms is adiabatically moved between a first arrangement and a second arrangement different from the first arrangement. The first array configuration comprises at least one pair of neutral atoms within a blockade radius of each other. A gate is applied to the at least one pair of neutral atoms when in the first arrangement. The plurality of neutral atoms is evolved according to a first Hamiltonian when in the second arrangement.

In various embodiments, a Raman pulse is applied to the at least one neutral atom during said moving. In various embodiments, the Raman pulse is applied at a midpoint of said moving.

In various embodiments, the adiabatic movement has a constant jerk. In various embodiments, the adiabatic movement has an average speed less than 0.55 μm/μs.

In various embodiments, the plurality of neutral atoms forms a two-dimensional array.

In various embodiments, the optical trap corresponding to the at least one neutral atom is generated by directing a beam of light to at least one acousto-optic deflector (AOD) and wherein adiabatically moving the optical trap corresponding to at least one neutral atom comprises varying a drive frequency of the at least one AOD. In various embodiments, at least a first subset of the optical traps corresponding to the plurality of neutral atoms is generated by directing a beam of light to a spatial light modulator (SLM).

According to various embodiments, a quantum computer is provided, comprising a plurality of optical traps, a source of a plurality of neutral atoms, each of the plurality of neutral atoms being disposable in a corresponding one of the plurality of optical traps, and at least one laser, wherein the quantum computer is configured to perform any of the foregoing methods.

### BRIEF DESCRIPTION OF THE SEVERAL VIEWS OF THE DRAWINGS

FIG. 1A is a schematic view of a quantum information architecture according to embodiments of the present disclosure.

FIG. 1B is a pair of images of neutral atoms before and after movement according embodiments of the present disclosure.

FIG. 1C is a graph of parity oscillations of stationary and transported atoms according to embodiments of the present disclosure.

FIG. 1D is a graph of measured Bell state fidelity as a function of separation speed according to embodiments of the present disclosure.

FIG. 2A is a series of images of neutral atoms illustrating generation of a 12-atom 1D cluster state graph according to embodiments of the present disclosure.

FIG. 2B is a quantum circuit representation of 1D cluster state preparation and measurement according to embodiments of the present disclosure.

FIG. 2C is a graph of raw measured stabilizers of the resulting 1D cluster state according to embodiments of the present disclosure.

FIG. 2D is a graph state representation of the 7-qubit Steane code according to embodiments of the present disclosure.

FIG. 2E is a circuit for preparing the Steane code logical state according to embodiments of the present disclosure.

FIG. 2F is a pair of graphs of measured stabilizers and logical operators according to embodiments of the present disclosure.

FIG. 3A shows a graph state realizing the surface code according to embodiments of the present disclosure.

FIG. 3B is a graph of measured X-plaquette and Z-star stabilizers of the resultant surface code according to embodiments of the present disclosure.

FIG. 3C is a schematic view of the implementation of the toric code according to embodiments of the present disclosure.

FIG. 3D shows measured X-plaquette and Z-star stabilizers, along with logical operators for two logical qubits with and without error detection according to embodiments of the present disclosure.

FIG. 4A shows a hybrid quantum circuit combining coherent atom transport with analog Hamiltonian evolution and digital quantum gates according to embodiments of the present disclosure.

FIG. 4B contains two atom images illustrating measuring entanglement entropy in a many-body Rydberg system via two-copy interferometry according to embodiments of the present disclosure.

FIG. 4C is a graph of measured half-chain Renyi entanglement entropy after many-body dynamics according to embodiments of the present disclosure.

FIG. 4D is a graph of mutual information for various system sizes according to embodiments of the present disclosure.

FIG. 4E is a graph of single-site Renyi entropies according to embodiments of the present disclosure.

FIG. 5A is a diagram of a CZ gate according to embodiments of the present disclosure.

FIG. 5B is a level diagram showing key ⁸⁷Rb atomic levels according to embodiments of the present disclosure.

FIG. 5C is a schematic of an exemplary pulse sequence for running a quantum circuit according to embodiments of the present disclosure.

FIGS. 6A-6D are graphs of atom loss and atom retention according to embodiments of the present disclosure.

FIGS. 7A-7C are graphs of pulse fidelity, coherence, and population difference according to embodiments of the present disclosure.

FIG. 8A is a schematic view of an exemplary pulse sequence according to embodiments of the present disclosure.

FIG. 8B is a graph of hyperfine coherence sequence according to embodiments of the present disclosure.

FIG. 8C is a graph of oscillation frequency according to embodiments of the present disclosure.

FIGS. 9A-9D are schematic views of the creation of a 1D cluster state, a Steane code, a surface code, and a toric code according to embodiments of the present disclosure.

FIGS. 10A-10B are graphs of error estimates according to embodiments of the present disclosure.

FIG. 10C is a tabulation of single-qubit (SQ) and two-qubit (TQ) gate errors according to embodiments of the present disclosure.

FIGS. 11A-11C are graphs of error probability and expectation value according to embodiments of the present disclosure.

FIGS. 12A-12B are graphs benchmarking interferometry measurement according to embodiments of the present disclosure.

FIGS. 13A-13C are graphs of raw many-body data and numerical modeling of errors according to embodiments of the present disclosure.

FIGS. 14A-14C are graphs of local observables and entanglement entropy for quantum many-body scars according to embodiments of the present disclosure.

FIG. 14D is a diagram of a constrained Hilbert space according to embodiments of the present disclosure.

FIG. 15 is a schematic view of an apparatus for quantum computation according to embodiments of the present disclosure.

### DETAILED DESCRIPTION

The ability to engineer parallel, programmable operations between desired qubits within a quantum processor is central for building scalable quantum information systems. In most state-of-the-art approaches, qubits interact locally, constrained by the connectivity associated with their fixed spatial layout. The present disclosure provides a quantum processor with dynamic, nonlocal connectivity, in which entangled qubits are coherently transported in a highly parallel manner across two spatial dimensions, in between layers of single-and two-qubit operations. This approach makes use of neutral atom arrays trapped and transported by optical tweezers: hyperfine states are used for robust quantum information storage, and excitation into Rydberg states is used for entanglement generation.

In various examples, this architecture is used to realize programmable generation of entangled graph states such as cluster states and a 7-qubit Steane code state. Furthermore, entangled ancilla arrays are shuttled to realize a surface code state with 13 data and 6 ancillary qubits and a toric code state on a torus with 16 data and 8 ancillary qubits. This architecture is also used to realize a hybrid analog-digital evolution and employ it for measuring entanglement entropy in quantum simulations, experimentally observing non-monotonic entanglement dynamics associated with quantum many-body scars. Realizing a long-standing goal, these results pave the way toward scalable quantum processing and enable new applications ranging from simulation to metrology.

A quantum bit (qubit) is the fundamental building block for a quantum computer. By analogy to classical bits which are used to store information in traditional computers (each bit is 0 or 1), qubits can occupy two distinct states labeled |0 [symbol] and |1 [symbol] , or any quantum superposition of the two states. In various applications, multiple qubits are entangled in order to build multi-qubit quantum gates.

Bits and qubits are each encoded in the state of real physical systems. For example, a classical bit (0 or 1) may be encoded in whether a capacitor is charged or discharged, or whether a switch is ‘on’ or ‘off’.

The term qudit (quantum digit) denotes the unit of quantum information that can be realized in suitable d-level quantum systems. A collection of qubits that can be measured to N states can implement an N-level qudit.

Quantum bits are encoded in quantum systems with two (or more) distinct quantum states. There are many physical realizations that may be employed. One example is based on individual particles such as atoms, ions, or molecules which are isolated in vacuum. These isolated atoms, ions, and molecules have many distinct quantum states that correspond to different orientations of electron spins, nuclear spins, electron orbits, and molecular rotations/vibrations.

In principle, a qubit may be encoded in any pair of quantum states of the atom/ion/molecule. In practice, a key parameter of qubits is described by their quantum coherence properties. Coherence measures the lifetime of the qubit before its information is lost. It has a close analogy with classical bits: if you prepare a classical bit in the 0 state, then after some time it may randomly be flipped to 1 due to environmental noise. Quantum mechanically, the same error may occur: |0 [symbol] may randomly flip to |1 [symbol] after some characteristic timescale. However, qubits may suffer from additional errors: for example, a superposition state (|0 [symbol] +|1 [symbol] )/√2 may randomly flip to (|0 [symbol] −|1 [symbol] )/√2. In real quantum computers, the qubits must be encoded in quantum states which have long coherence properties.

Quantum computers generally can contain many qubits, each encoded in its own atom/molecule/ion/etc. Beyond simply containing the qubits, the quantum computer should be able to (1) initialize the qubits, (2) manipulate the state of the qubits in a controlled way, and (3) read out the final states of the qubits. When it comes to manipulation of the qubits, this is usually broken down into two types: one type of qubit manipulation is a so-called single-qubit gate, which means an operation that is applied individually to a qubit. This may, for example, flip the state of the qubit from |0 [symbol] to |1 [symbol] , or it may take |0 [symbol] to a superposition state (|0 [symbol] +|1 [symbol] )/√2. The second necessary type of qubit manipulation is a multi-qubit gate, which acts collectively on two or more qubits, including those that are entangled. A multi-qubit gate is realized through some form of interaction between the qubits. The various quantum computing platforms (having various physical encodings of qubits) rely on different physical mechanisms both for single-qubit gates as well as multi-qubit gates according to the physical system that is storing the qubit.

In various embodiments of a quantum computer, a qubit is encoded in two near-ground-state energy levels of an atom, ion, or molecule. An example of this is a hyperfine qubit. Such a qubit is encoded in two electronic ground states that differ by the relative orientation of the nuclear spin with respect to the outer electron spin. Pairs of such states can be chosen so that they are particularly robust/insensitive to environmental perturbations, leading to long coherence times. These states are split in energy by the hyperfine interaction energy of the atom/ion/molecule, which is the interaction energy between the nuclear spin and the electron spin. The robustness of the qubit can be understood as the energy splitting between the two states being particularly stable. For this reason, such states are called clock states because the stable energy splitting can form an excellent frequency-reference and as such forms the basis for atomic clocks. Typical hyperfine splitting between these qubit states is in the 1-13 GHz frequency range.

To perform single-qubit gates on such a hyperfine qubit, it is possible to apply coherent microwave radiation at the exact frequency of the energy splitting between states. However, there are two drawbacks to this approach. First, microwaves cannot be applied to just one qubit without affecting adjacent qubits. This is because qubits are encoded in particles that are typically just a few microns apart from one another, and microwaves cannot be focused to such a small scale due to their large wavelength. Second, the microwave intensity is fairly limited and as such the maximum speed of single-qubit gates is correspondingly limited.

An alternative approach is based on stimulated Raman transitions. In this case, a laser field is applied to the atoms/ions/molecules. The laser field is nearly (but not exactly) resonant with an optical transition from one of the ground states to an optically excited state. The laser contains multiple frequency components separated in frequency by exactly the amount equal to the hyperfine splitting of the qubit. The atom/ion/molecule can absorb a photon from one frequency component and coherently emit into a different frequency component, and in doing so it changes its state. This approach benefits from the capability of focusing the laser field onto individual particles or subsets of particles in the quantum computer. The laser field can also be applied with high intensity, allowing much faster gate operations.

Neutral atom quantum computers encode qubits in individual neutral atoms. The neutral atoms are trapped in a vacuum chamber and levitated by trapping lasers. Most commonly, the trapping lasers are individual optical tweezers, which are individual tightly focused laser beams that trap an individual atom at the focus. Alternatively, individual atoms may be trapped in an optical lattice, which is formed from standing waves of laser light which produce a periodic structure of nodes/antinodes.

A typical approach for encoding a qubit in neutral atoms is the hyperfine qubit approach, in which two ground states split by several GHz form the qubit. Multi-qubit gates in neutral atom quantum computers are realized using a third atomic state, which is a highly-excited Rydberg state. When one atom is excited to a Rydberg state, neighboring atoms are prevented from being excited to the Rydberg state. This conditional behavior forms the basis for multi-qubit gates, such as a controlled-NOT gate. The Rydberg state is used temporarily to mediate the multi-qubit gate, and then the atoms are returned back from the Rydberg state to the ground state levels to preserve their coherence.

Trapped ion quantum computers use atomic species that are ionized, meaning they have a net charge. In most cases, many ions are trapped in one large trapping potential formed by electrodes in a vacuum chamber. The ions are pulled to the minimum of the trapping potential, but inter-ion Coulomb repulsion causes them to form a crystal structure centered in the middle of the trapping potential. Most commonly, the ions arrange into a linear chain. Other ways to trap ions are also possible, such as using optical tweezers, or trapping ions individually with local electric fields with a more complex on-chip electrode structure.

Qubits are encoded in trapped ions in multiple ways. One common approach is to use ground-state hyperfine levels, as described for neutral atoms. In trapped ions with hyperfine-qubit encoding, as with neutral atoms, single-qubit gates may use microwave radiation or stimulated Raman transitions.

Unlike in neutral atoms, trapped ion hyperfine qubits rely heavily on stimulated Raman transitions for performing multi-qubit gates. Stimulated Raman transitions may be used to control both the hyperfine state of the ion but also to change the motional state of the ion (i.e., add momentum). This can be understood as absorbing a photon moving in one direction and emitting a photon in a different direction, such that the difference in photon momentum is absorbed by the ion. Since many ions are often trapped in one collective trapping potential and are mutually repelling one another, changing the motional state of one ion affects other ions in the system, and this mechanism forms the basis for multi-qubit gates.

According to various embodiments of a quantum computer, individual particles (atoms/ions/molecules) can first be trapped in an array and arranged into particular configurations. Next, one or more particles are prepared in a desired quantum state. Quantum circuits can then be implemented by a sequence of qubit operations acting on individual qubits (single-qubit gates) or on groups of two or more qubits (multi-qubit gates). Finally, the state of the particles can be read out in order to observe the result of the quantum circuit. The readout can be accomplished using an observation system that typically includes an electron-multiplied CCD (EMCCD) camera image to detect particles' loaded positions, and a second camera image to read out the particles' final states by, for example, detecting fluorescence emitted by the particles in their final states.

Quantum information platforms rely on interactions between qubits, either for performing quantum gates or for performing analog many-body simulation. Qubits often interact in a local way, however, which limits the connectivity of the circuit or the analog simulation and constrains the possible computations. While some platforms can communicate in a nonlocal way through the use of a shared bus (e.g., trapped ions), these shared-bus approaches are limited to small systems and thus still require a way to dynamically move qubits around in order to truly scale up the platform.

The present disclosure shows that neutral atom arrays can be dynamically reconfigured while preserving quantum coherence and entanglement between qubits, by storing quantum information in hyperfine states and shuttling atoms in optical tweezers. This approach offers a scalable way to realize a quantum information system with large numbers of qubits and arbitrary programmability-where any qubit can perform an entangling gate with any other qubit in the array. Using high-fidelity two-qubit Rydberg gates, various quantum information circuits are described herein that leverage the programmability and nonlocal connectivity achievable with these approaches. An example of high fidelity Rydberg gates is described in Levine, et al., Parallel Implementation of High-Fidelity Multiqubit Gates with Neutral Atoms, Phys. Rev. Lett., vol. 123, issue 17, https://link.aps.org/doi/10.1103/PhysRevLett.123.170503, which is hereby incorporated by reference.

The approaches described herein are naturally suited for making stabilizer states, or graph states, which are an important class of quantum information states defined by graphs, and some of these graphs have nonlocal connectivity. In particular, the present disclosure demonstrates preparation of a 1D cluster state, a 7-qubit Steane code quantum error correcting code, and a surface code quantum error correcting code, with high fidelities.

To further demonstrate the true nonlocal capabilities of these approaches, the present disclosure demonstrates entanglement of qubits on opposite ends of the array to implement periodic boundary conditions with 24 qubits and realize a toric code, on a torus. The toric code is a canonical topological error correcting code whose physical realization is impractical in other systems due to the nonlocal connectivity required, and highlights the unique capabilities of this approach.

The approaches provided herein offer a variety of new tools for analog quantum simulation with Rydberg atoms, as well. As an example of this, the present disclosure demonstrates a quantum many-body quench on two identical many-body copies, and then interfere the two systems with a gate-based protocol, yielding the entanglement entropy of the system—an important quantity which has previously not been experimentally measured in Rydberg atom systems.

It will be appreciated that the approaches described herein have a variety of advantages, including the ability to maintain coherence of a qubit during motion and the ability to avoid breaking entanglement during motion.

As set out in more detail below, the methods provided herein enable a variety of computational scenarios. In some scenarios, a plurality of neutral atom are moved in parallel between multiple regions in space. For example, a source of illumination may be directed to a first region, and atoms are moved in and out of that region between the application of pulses by the source of illumination. Similarly, a camera may be directed to an imaging region, and atoms are moved in and out of that imaging region for imaging. Similarly, atoms may be moved in and out of the blockade radius of other atoms, thereby allowing the application of gates to the different groups of atoms at different stages of an algorithm or layers of a quantum circuit.

It will be appreciate that various stabilizer codes entail the readout of ancilla qubits, and the present disclosure allows the physical relocation of ancilla qubits to an imaging region separate from the data qubits. In this way, readout of ancilla qubits may be provided without destruction of the data qubits.

More generally, an array of atoms may be moved between multiple arrangements in order to facilitate both digital gates between different selections of atoms and analog evolution of the array as a whole. As used herein, an arrangement of an array of atoms or a plurality of atoms refers to the positioning of those atoms relative to each other. It will be appreciated that certain arrangements provide connectivity between qubits that enable particular gates or analog evolution according to a particular Hamiltonian. One advantage of the methods provided herein is that atoms may be moved into proximity of atoms that were not adjacent within an array. A non-adjacent atom is one that is not within a unit cell in a regular lattice or that is not a nearest neighbor in an irregular array. For example, in a rectangular lattice, each atom has eight atoms that are within a unit cell thereof, and thus has eight adjacent atoms (disregarding edges).

As defined further below, atoms are moved adiabatically in order to preserve entanglement. As used herein, the term adiabatic movement refers to movement that avoids a transition of the subject atom within its trap. For example, where the first time-derivative of the acceleration of the subject atom is not greater than a predetermined value the movement is considered adiabatic. Typically, adiabatic movement occurs when jerk<(size of atom)×(trap frequency)³. In physics, jerk or jolt is the term given to the rate at which an object's acceleration changes with respect to time.

In addition to adiabatic movement, in some embodiments dynamical decoupling is applied during the movement. As set out further below, a π-pulse during movement cancels out dephasing induced by the trap differential light shift. The trap differential light shift changes when the atom is moving (depending on its acceleration) because it will move in the trap, and so sample a different portion of the light intensity and hence have a different differential light shift.

Generally speaking, the more pulses applied, the more decoupling from fluctuations. For example, fluctuations may come from laser intensity fluctuations at different displacement positions of the atom, or different magnetic fields in space.

In embodiments where acceleration and deceleration are symmetric, both change the differential light shift in the same way. Accordingly, in such embodiments it is advantageous to apply a π-pulse at the midpoint of the motion. In this way, the changes in differential light shift induced by acceleration and deceleration cancel each other out.

As is known in the art, analog evolution of a system of neutral atoms under a Hamiltonian may be used to perform quantum simulation and related problems. As described below, the methods provided herein may be used to move atoms into an arrangement suitable for analog Hamiltonian evolution according to given Hamiltonian. Atoms may additionally be moved back and forth between such arrangements and arrangements suitable for application of digital quantum gates.

In the below examples, such an approach is described for measuring the entanglement entropy in a many-body system. However, it will be appreciated that the approach may be used for a variety of additional problems. For example, moving atoms between multiple arrangements and performing multiple rounds of analog evolution allows formulation of maximum independent set problems on graphs with nonlocal connectivity. By using digital gates and multiple copies, one can perform error mitigation on analog quantum simulators. More generally, applying gates in this way allows controlling an analog evolution (such as a spin liquid) more precisely. This control may additionally be used to do shadow tomography in a complex system as a way of probing many-body physics.

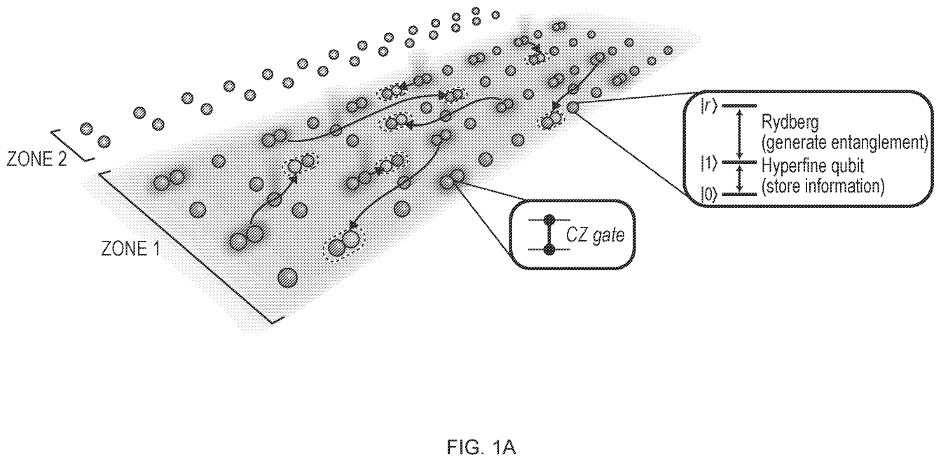

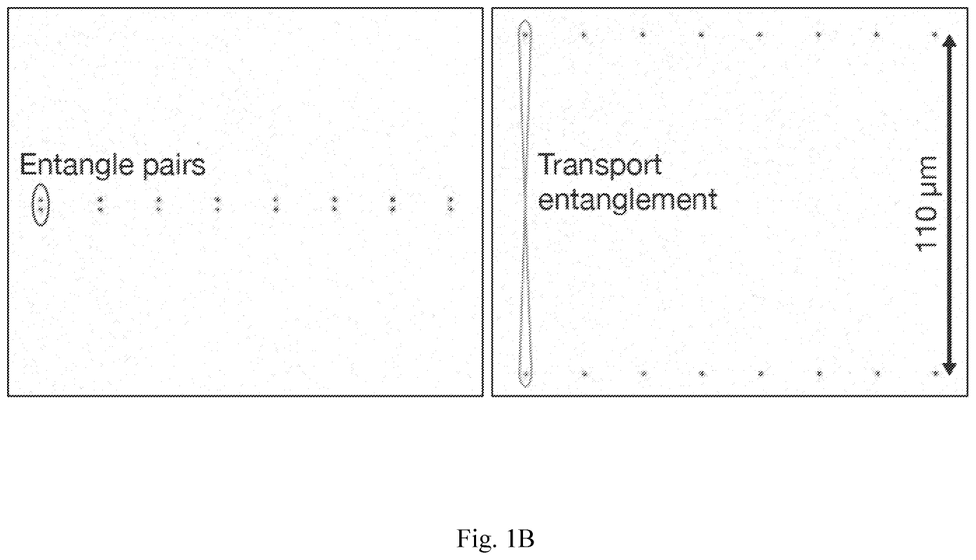

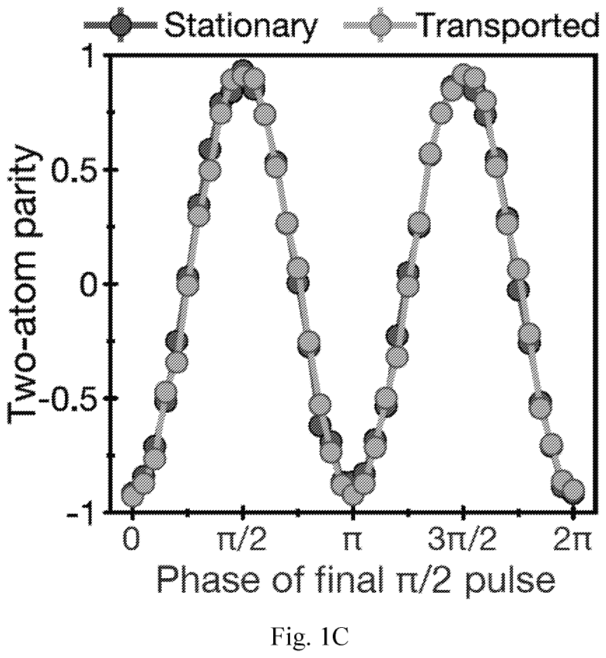

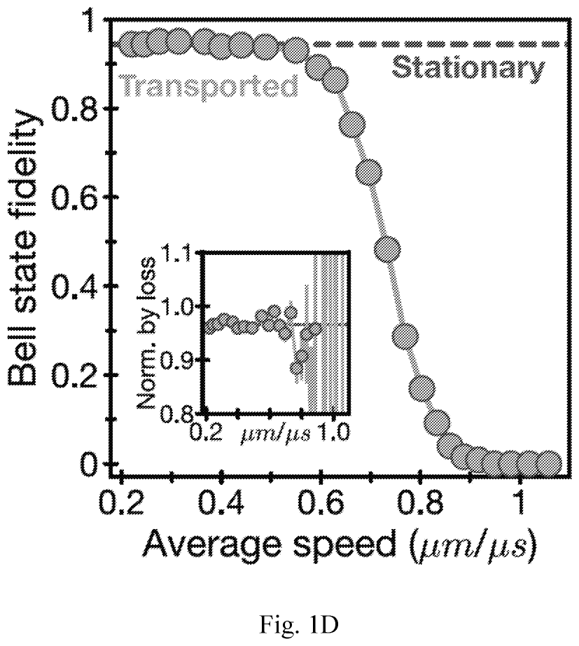

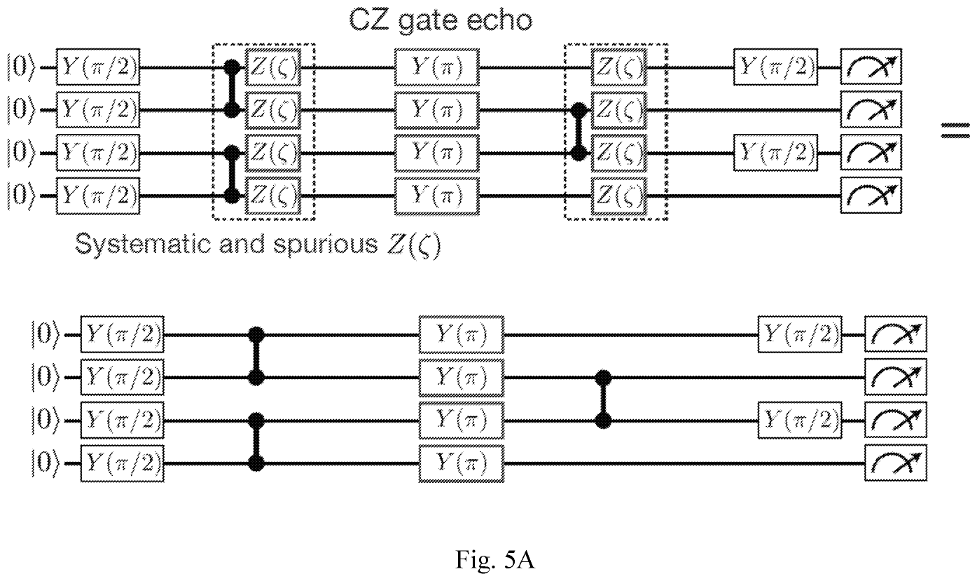

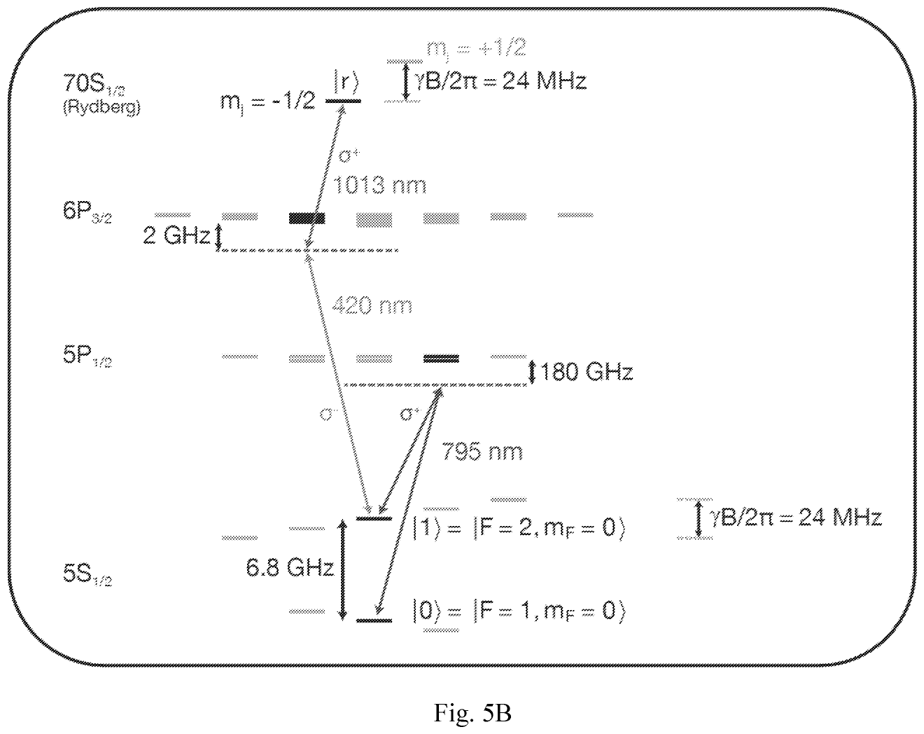

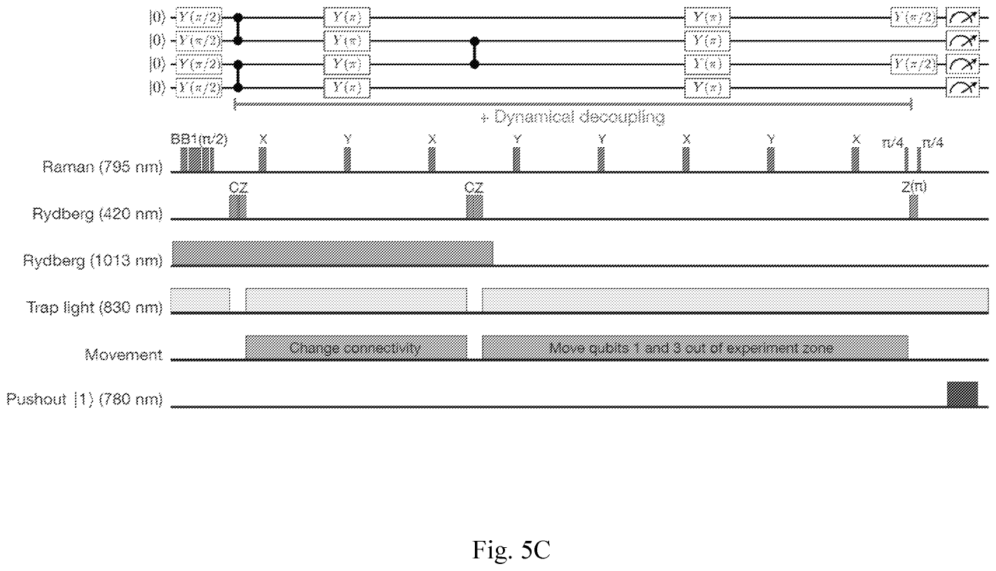

Referring to FIG. 1, a quantum information architecture enabled by coherent transport of neutral atoms is illustrated. Qubits are transported to perform entangling gates with distant qubits, enabling programmable and nonlocal connectivity. Atom shuttling is performed using optical tweezers, with high parallelism in two dimensions and between multiple zones allowing selective manipulations. Inset shows the atomic levels used: the |0 [symbol] , |1 [symbol] qubit states refer to the m_{F}=0 clock states of ⁸⁷Rb, and |r [symbol] is a Rydberg state used for generating entanglement between qubits (FIG. 5B). FIG. 1B shows atom images illustrating coherent transport of entangled qubits. Using a sequence of single-qubit and two-qubit gates, atom pairs are each prepared in the |Φ⁺ [symbol] Bell state, and are then separated by 110 μm over a span of 300 μs. FIG. 1C is a graph showing parity oscillations that indicate that movement does not observably affect entanglement or coherence. For both the moving and stationary measurements, qubit coherence is preserved using an XY8 dynamical decoupling sequence for 300 μs. FIG. 1D is a graph of measured Bell state fidelity as a function of separation speed over the 110 μm, showing that fidelity is unaffected for a move slower than 200 μs (average separation speed of 0.55 μm/μs). Inset: normalizing by atom loss during the move results in constant fidelity, indicating that atom loss is the dominant error mechanism.

Quantum information systems derive their power from controllable interactions that generate quantum entanglement. However, the natural, local character of interactions limits the connectivity of quantum circuits and simulations. Nonlocal connectivity can be engineered via a global shared quantum data bus, but these approaches are limited in either control or size.

According to various embodiments of the present disclosure, this long-standing challenge is addressed through dynamically reconfigurable arrays of entangled neutral atoms, shuttled by optical tweezers in two spatial dimensions (FIG. 1A). Hyperfine states are used for storing and transporting quantum information in between quantum operations, and excitation into Rydberg states is used for generating entanglement. Highly parallel operations are enabled via selective qubit operations in distinct zones that qubits are dynamically shuttled between. Taken together, these ingredients enable a powerful quantum information architecture, which is employed to realize applications including entangled state generation, creation of topological surface and toric code states, and hybrid analog-digital quantum simulations.

### Entanglement Transport in Atom Arrays

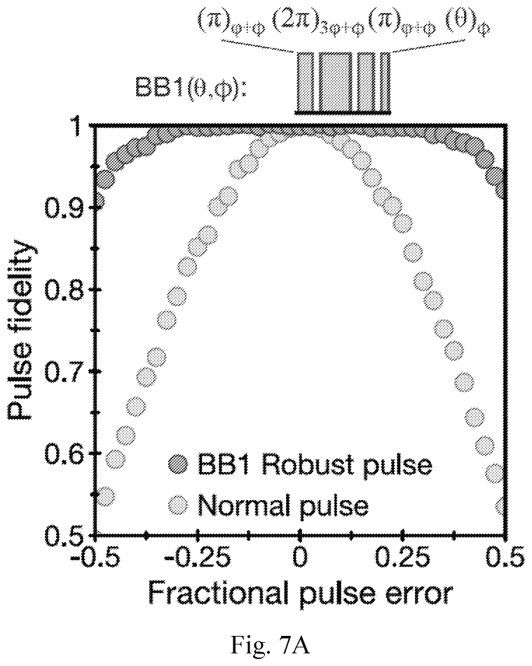

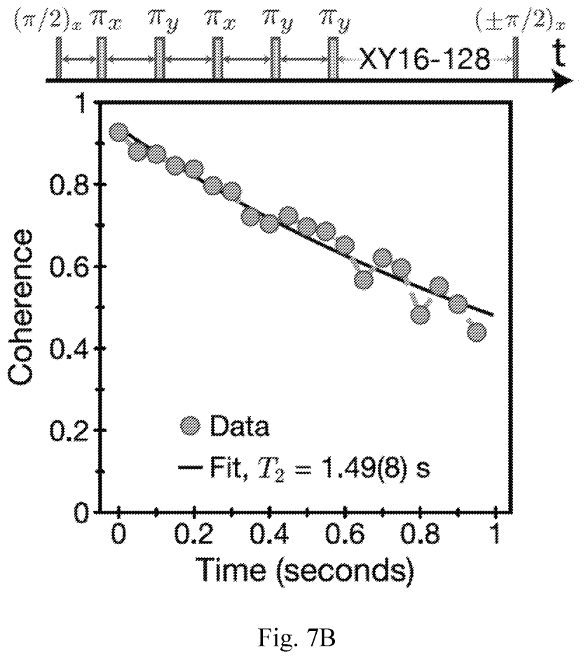

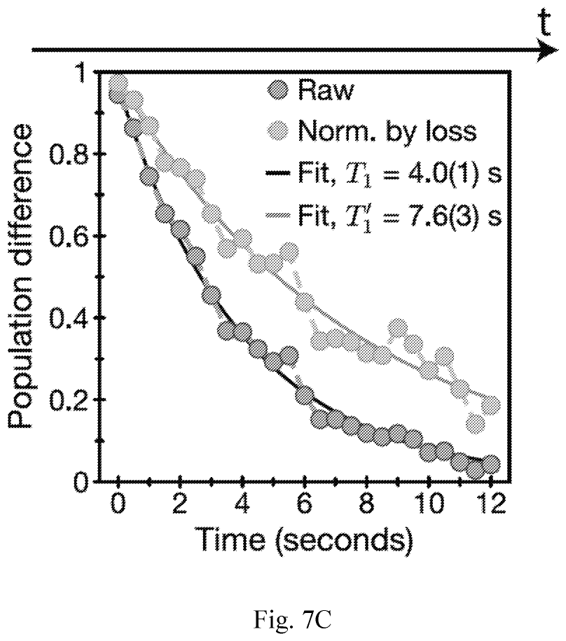

In various embodiments, a two-dimensional atom array system as described below is used to implement coherent transport and multiple layers of single-qubit and two-qubit gates. Quantum information is stored in magnetically insensitive clock states within the ground state hyperfine manifold of ⁸⁷Rb atoms. Robust single-qubit Raman rotations (scattering error per π-pulse ˜7×10⁻⁵) are realized by composite pulses that are robust to pulse errors (FIGS. 7A-B). High-fidelity controlled-Z (CZ) entangling gates in the hyperfine basis {|0 [symbol] , |1 [symbol] (FIG. 1A) are implemented in parallel using global Rydberg excitation pulses on the |1 [symbol] ↔|r [symbol] transition. For dynamic reconfiguration, atoms are deployed in two sets of traps: static traps generated by a spatial light modulator (SLM) and mobile traps generated by a crossed 2D acousto-optic deflector (AOD). To execute a specific circuit, qubits are arranged into desired pairs, and Rydberg-mediated CZ gates are performed on each pair simultaneously. All mobile traps are then moved in parallel to dynamically change the connectivity into the next desired qubit arrangement.

FIGS. 1A-D demonstrate the ability to transport qubits across large distances while preserving entanglement and coherence. Pairs are initialized at an atom-atom distance of 3 μm (FIG. 1B) and then a Bell state

$$\vert {Φ}^{+} 〉 = \frac{1}{\sqrt{2}} ( \vert 00 〉 + \vert 11 〉 )$$

is created in the hyperfine basis. To measure the resulting entangled-state fidelity, a variable single-qubit phase gate is applied before a final π/2 pulse, resulting in oscillations of the two-atom parity [symbol] σ₁^{z}σ₂^{z} [symbol] (FIG. 1C). This experiment was repeated, with the atoms moved apart by 110 μm before applying the final π/2 pulse. The transport protocol is optimized to suppress heating and loss by implementing cubic-interpolated atom trajectories, and is further accompanied by an 8-pulse XY8 robust dynamical decoupling sequence to suppress dephasing. The resulting parity oscillations indicate that two-atom entanglement is unaffected by the transport process. Performing this experiment as a function of movement speed shows that fidelity remains unchanged until the total separation speed becomes >0.55 μm/μs, corresponding to the onset of atom loss (FIG. 1D). The entanglement transport in FIG. 1B corresponds to moving quantum information across a region of space that can in principle host ˜2000 qubits (at an atom separation of 3 μm), on a timescale corresponding to <10⁻³T₂ (FIG. 7), directly enabling applications in large-scale quantum information systems.

### Programmable Circuits and Graph States

To exemplify the ability to generate nonlocal connectivity between qubit arrays in parallel, entangled graph states are prepared as follows: a large class of useful quantum information states, with examples ranging from GHZ states and cluster states to quantum error correction codes. Graph states are defined by initializing all qubits, located on the vertices of a geometric graph, in

$$\vert + 〉 ≡ \frac{\vert 0 〉 + \vert 1 〉}{\sqrt{2}}$$

and then performing Cz gates on the links between qubits (corresponding to the edges of the graph). N-qubit graph states |G [symbol] are associated with a set of N stabilizers, defined by Sᵢ=XᵢΠ_{j∈u}_{ᵢ}Zⱼ, where uᵢ is the set of qubits (vertices) connected by an edge to qubit i. The stabilizers each have +1 eigenvalue for the graph state |G [symbol] . Measuring these operators and their expectation values can be used to characterize preparation of the target state.

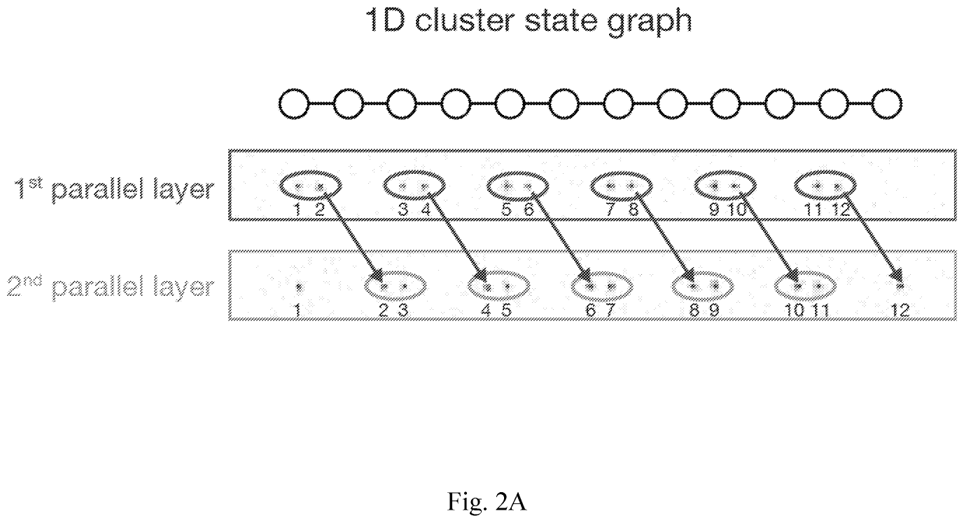

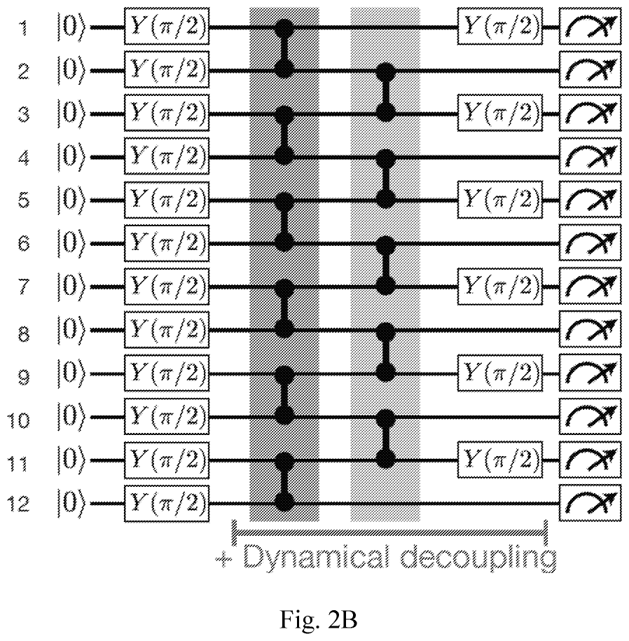

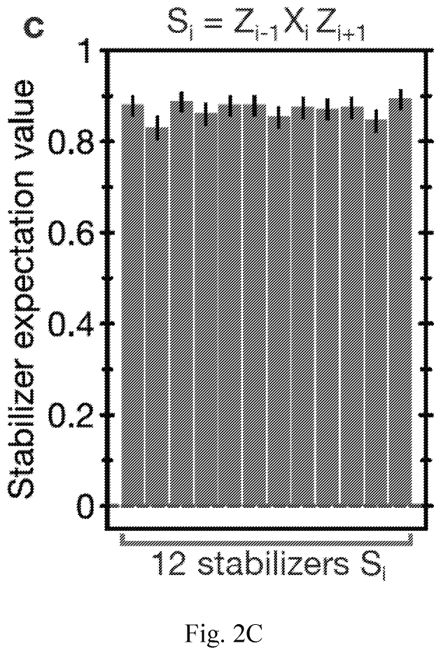

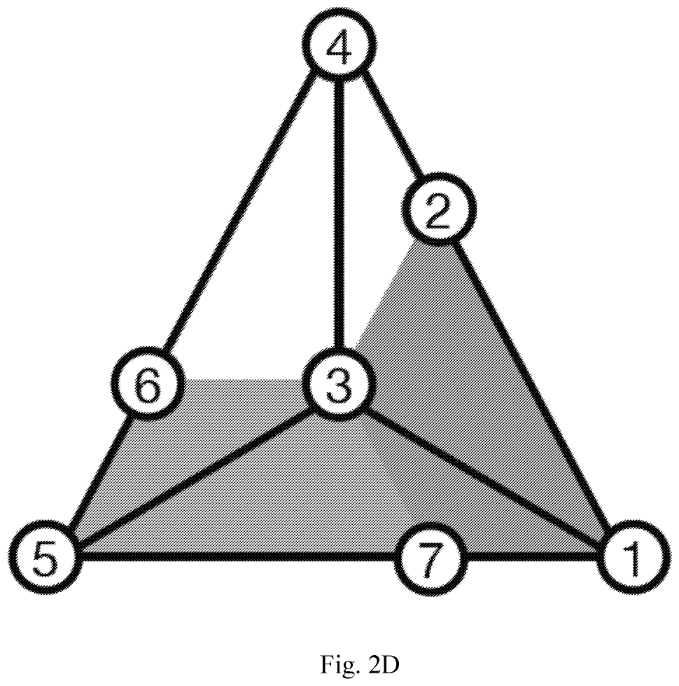

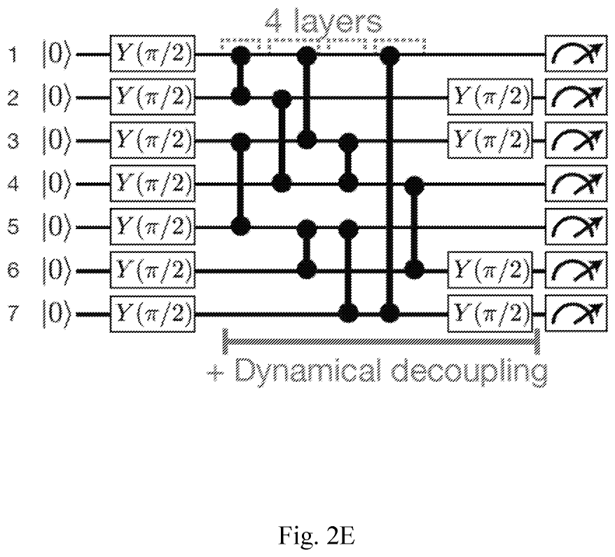

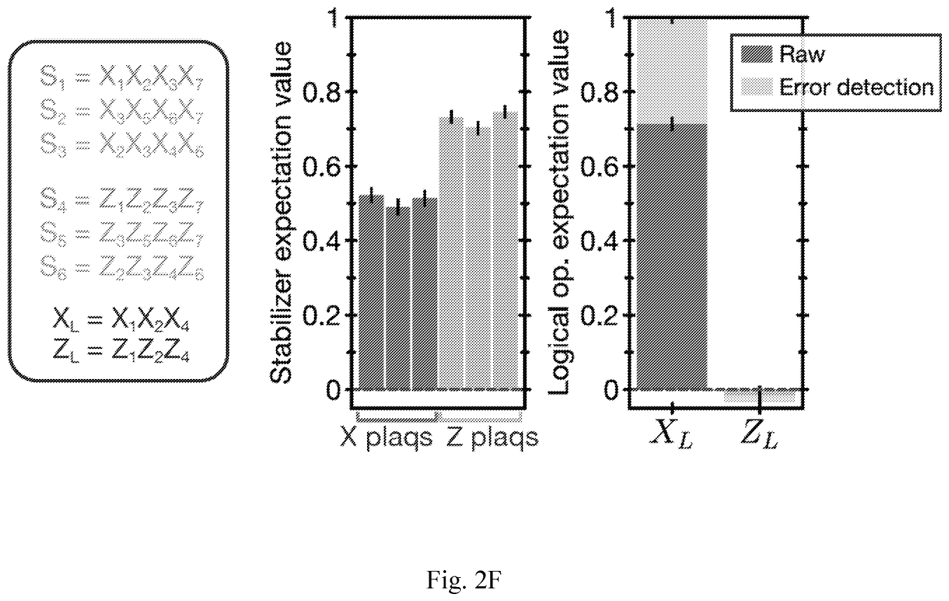

Referring to FIG. 2, 1D and 2D graph states using dynamic entanglement transport are illustrated. In FIG. 2A, generation of a 12-atom 1D cluster state graph is illustrated, created by initializing all qubits (vertices) in |+ [symbol] and applying controlled-Z gates on the links (edges) between qubits. Atom images show the configuration for the first and second gate layers. FIG. 2B shows a quantum circuit representation of the 1D cluster state preparation and measurement. Dynamical decoupling is applied throughout all quantum circuits (see Methods). FIG. 2C shows raw measured stabilizers of the resulting 1D cluster state, given by Sᵢ=Zᵢ₋₁XᵢZᵢ₊₁ (X₁Z₂ and Z₁₁X₁₂ for the edge qubits). FIG. 2D shows a graph state representation of the 7-qubit Steane code (shading represents stabilizer plaquettes). FIG. 2E shows a circuit for preparing the Steane code logical |+ [symbol] _{L} state, performed in four parallel gate layers. FIG. 2F shows measured stabilizers and logical operators after preparing |+ [symbol] _{L}. Error detection is done by postselecting on measurements where all stabilizers are +1. For both the 1D cluster state and Steane code, the stabilizers and logical operators are measured with two measurement settings. Error bars represent 68% confidence intervals.

FIG. 2A demonstrates preparation of a 1D cluster state, a graph state defined by a linear chain of qubits. To realize this state, one global, parallel layer of CZ gates is performed on adjacent atom pairs, half the atoms are moved to form new pairs, and then another parallel layer of CZ gates is performed (FIGS. 2A,B). To probe the resultant twelve-qubit cluster state the stabilizer set {Sᵢ}={Zᵢ₋₁XᵢZᵢ₊₁} is measured through readout in two measurement settings, given by a local π/2 rotation on either the odd or even sublattice before projective measurement. The local rotation is achieved by moving one sublattice of qubits to a separate zone and then performing a rotation on the unmoved qubits with a homogeneous beam illuminating the experiment zone (FIG. 1A, Methods). [symbol] Sᵢ [symbol] is measured by analyzing the resulting bit-string outputs and plotting the resulting raw stabilizer measurements (FIG. 2C). Across all twelve stabilizers an average [symbol] Sᵢ [symbol] =0.87(1) is found (FIG. 2C) (accounting for state-preparation-and-measurement SPAM errors would yield [symbol] Sᵢ [symbol] =0.91(1)), certifying biseparable entanglement in a cluster state (all [symbol] Sᵢ>0.5). The measured fidelities would correspond to a few percent error-per-operation for a measurement-based quantum computation.

An important class of graph states are quantum error correcting (QEC) codes, where the graph state stabilizers manifest as the stabilizers of the QEC code and can be measured to correct errors on an encoded logical qubit. In fact, all stabilizer QEC states are equivalent to some graph state up to single-qubit Clifford rotations, hence the ability to generate arbitrary graph states allows one to readily prepare a wide variety of QEC states.

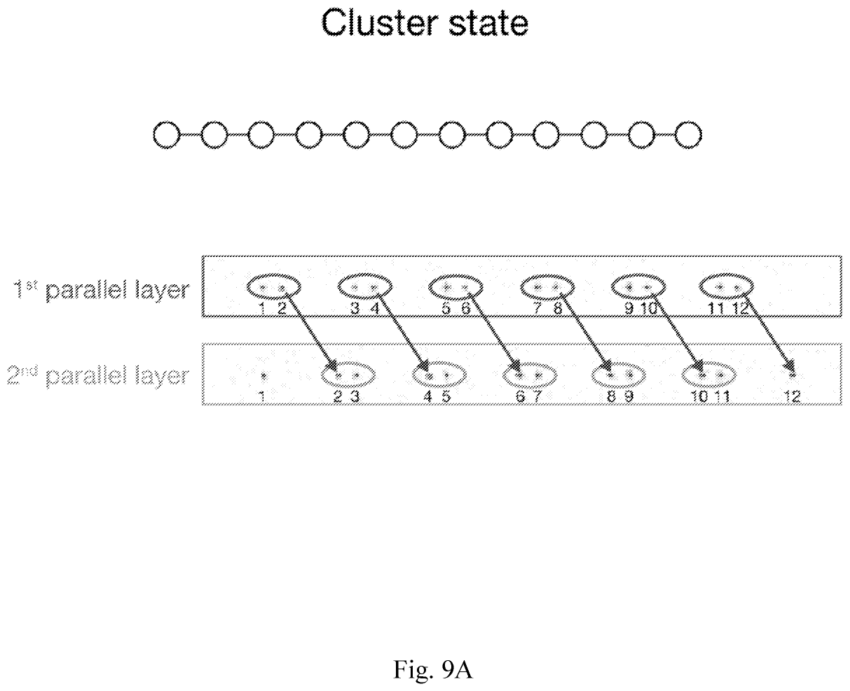

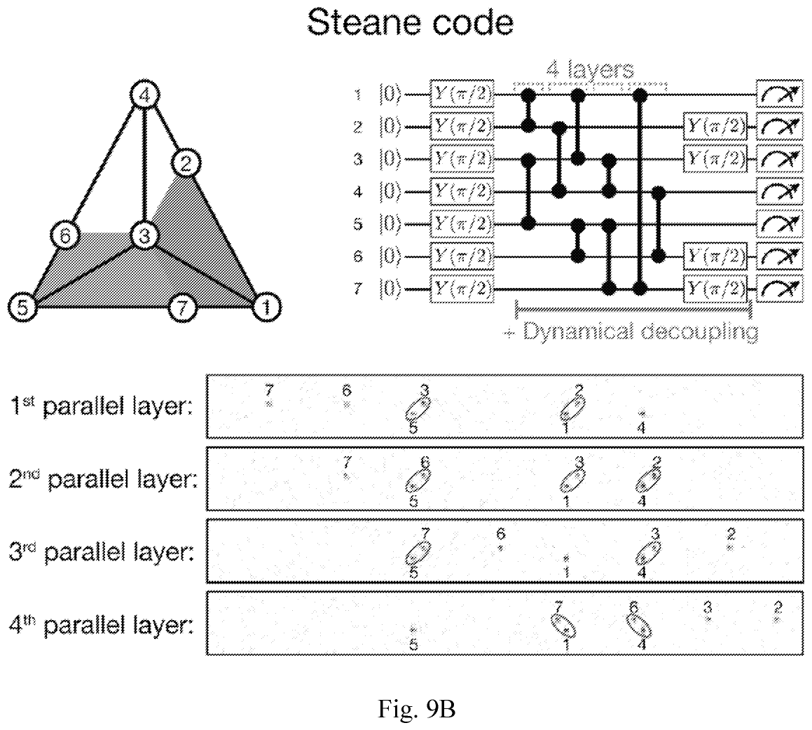

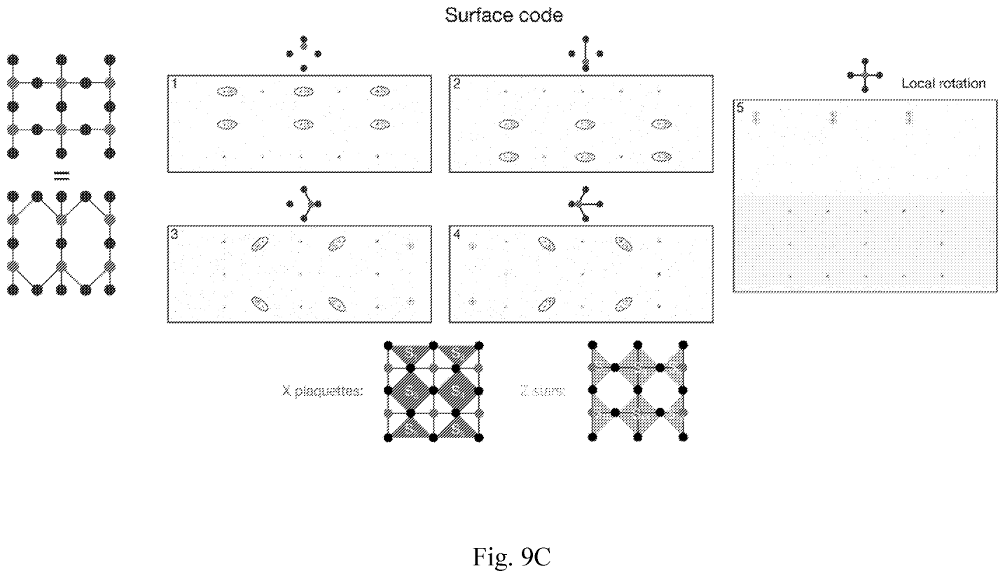

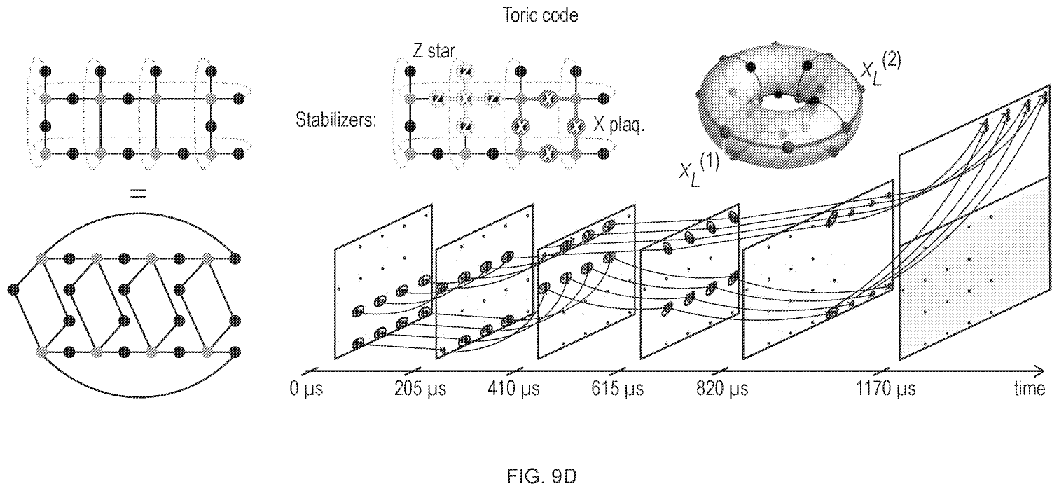

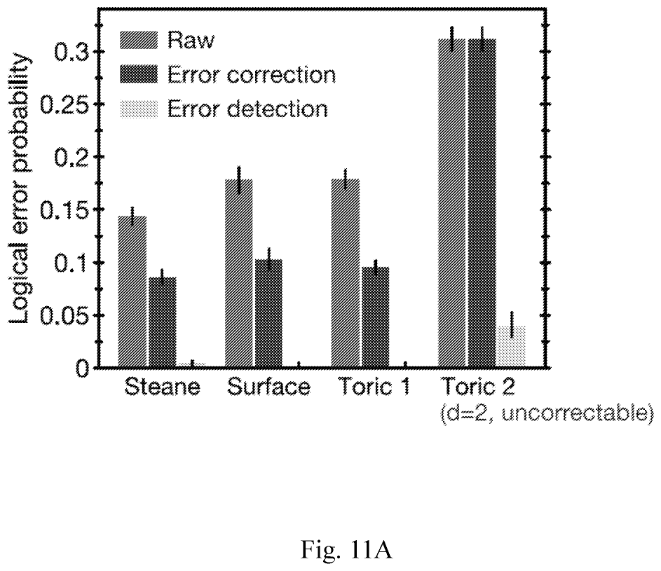

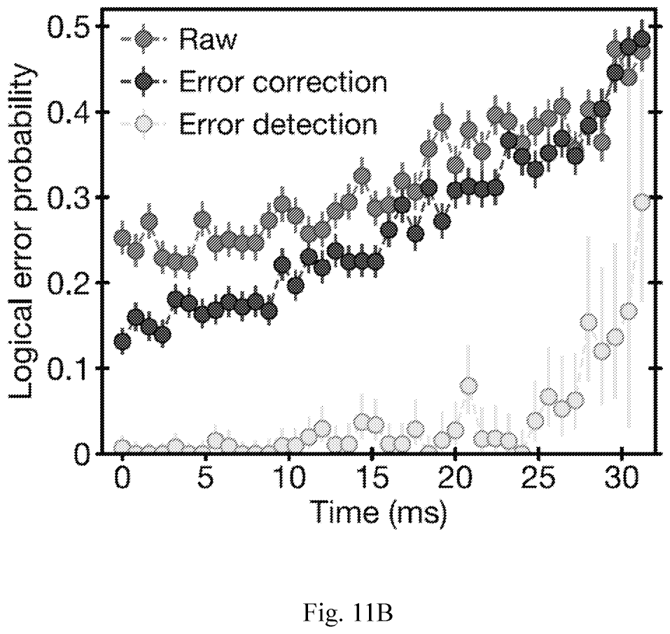

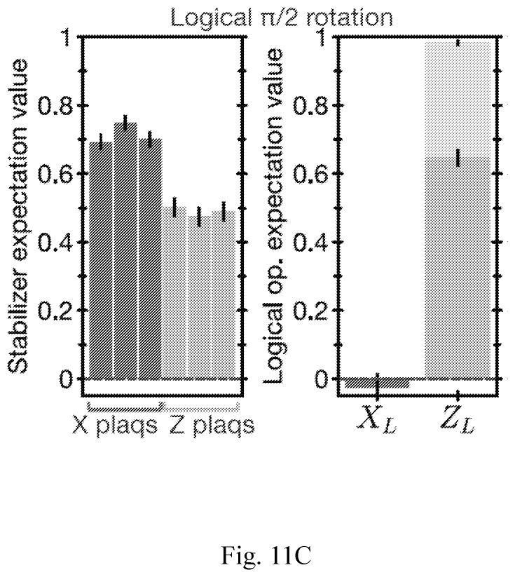

As an example, the 7-qubit Steane code, a topological color code depicted by the graph in FIG. 2D, is prepared in the logical state |+ [symbol] _{L}. To prepare this state, all qubits are initialized in |+ [symbol] , and CZs are applied on the links between qubits (in four parallel layers, see FIG. 9B). Either of the two sublattices is then rotated for measuring stabilizers (FIG. 2E). After sublattice rotation, six of the graph state stabilizers transform into the six Steane code stabilizers, given by four-body products of Xᵢ or Zᵢ. FIG. 2F shows the raw measured expectation values of these six stabilizers. The seventh graph state stabilizer transforms into the logical qubit operator X_{L} and has eigenvalue +1 for the graph state |G [symbol] , while anticommuting with logical Z_{L}. Accordingly, in FIG. 2F [symbol] X_{L} [symbol] =0.71(2) and [symbol] Z_{L}=−0.02(3), demonstrating preparation of the logical qubit state |+ [symbol] _{L}. Moreover, error detection is performed by post-selecting on measurement outcomes where all measured stabilizers yield +1 (with 66(1)% probability of no detected errors). Using this procedure corrected values [symbol] X̅_̅{̅L̅}̅ [symbol] =0.991^{+0.004}_{-0.007} and [symbol] Z̅_̅{̅L̅}̅=−0.03(3) are obtained, demonstrating the error detecting properties of the Steane code graph (see FIG. 11 for error correction and logical operations).

### Topological States with Ancilla Arrays

Transportable ancillary qubit arrays are also used to mediate quantum operations between remote qubits. Due to the ability to quickly move arrays of atoms across the entire system, the use of ancillary qubits naturally complements the movement capabilities provided herein. Specifically, ancillas are employed for state preparation by mediating entanglement between physical qubits that never directly interact, followed by projective measurement of the ancilla array (performed simultaneously with the measurement of the data qubits), a form of measurement-based quantum computation. In particular, topological surface code and toric code states are prepared, whose states are more difficult to construct by direct CZ gates between physical qubits (requiring an extensive number of layers). For these codes the measured values of the ancilla qubits simply redefine the stabilizers and are handled in-software for practical QEC operation. Since the redefinition is applied in-software, without physical intervention, the projective measurements on the ancillae commute with all operations on the data qubits and can be done at any time, and so all qubits are measured simultaneously.

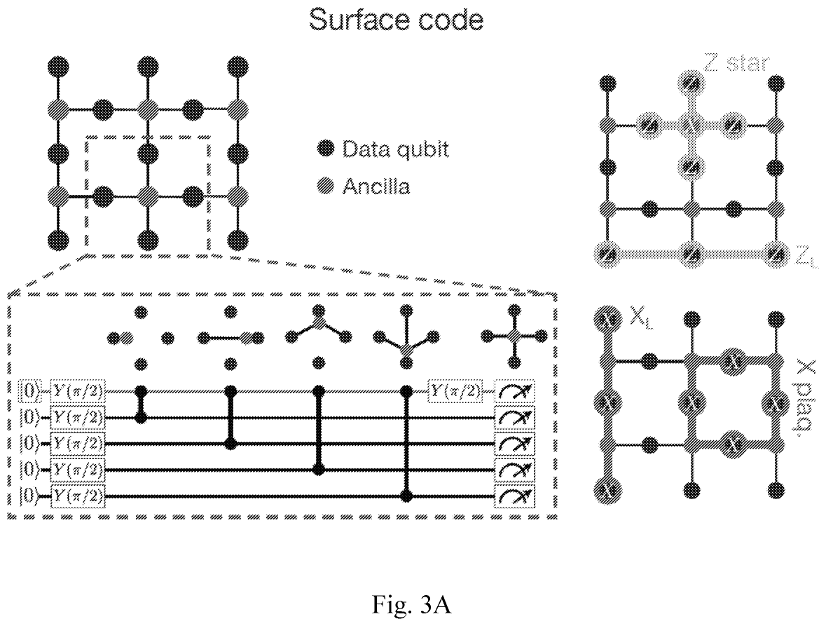

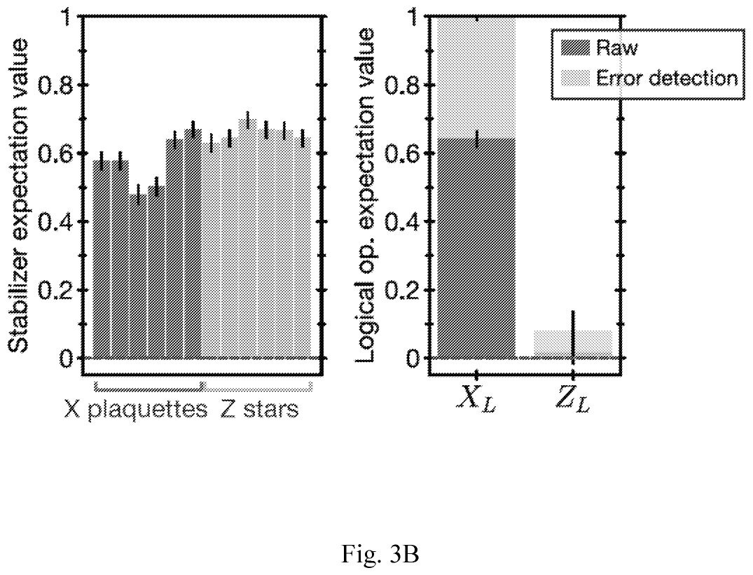

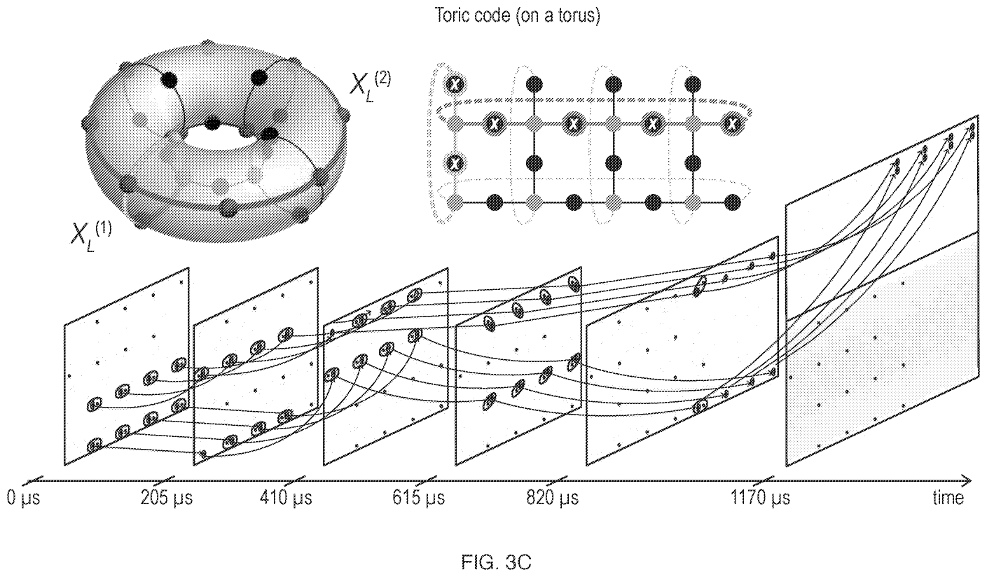

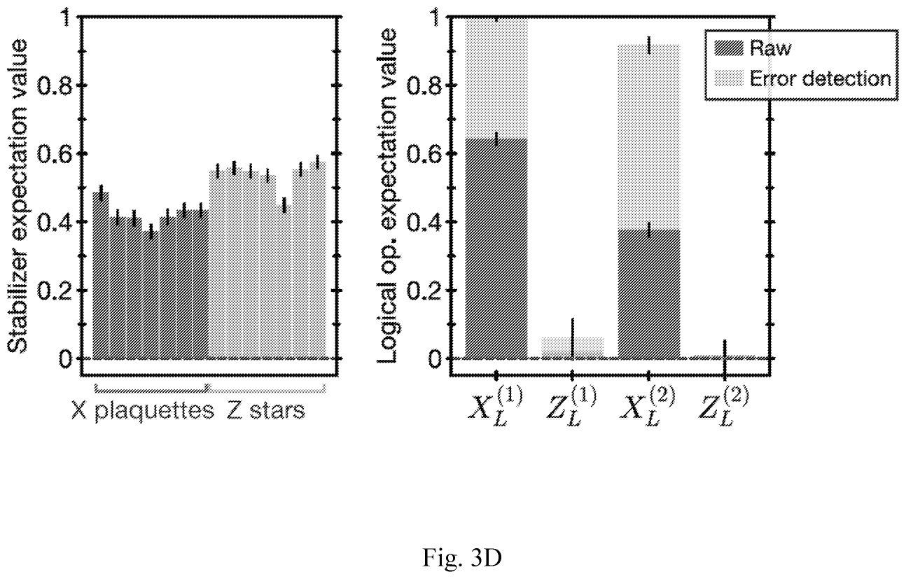

Referring to FIG. 3, topological surface code and toric code states using mobile ancilla qubit arrays are illustrated. FIG. 3A shows a graph state realizing the surface code. The circuit depicts formation of the graph state by use of mobile ancilla qubits; each move corresponds to performing a CZ gate with a neighboring data qubit (illustrated in box). The logical |+ [symbol] _{L} state is created upon projective measurement of the ancilla qubits in the X-basis. Right schematics depict stabilizers and logical operators of the code. FIG. 3B shows measured X-plaquette and Z-star stabilizers of the resultant surface code, along with logical operators with and without error detection (implemented in postselection).

FIG. 3C illustrates implementation of the toric code. (Top) Graph state realizing the two logical-qubit product state |+ [symbol] _{L}¹|+ [symbol] _{L}² of the toric code upon projective measurement of the ancilla qubits in the X-basis. (Bottom) Images showing the movement steps implemented in creating and measuring the toric code state (see supplementary movie). Shading in the final image represents a local rotation on the data qubit zone. FIG. 3D shows measured X-plaquette and Z-star stabilizers, along with logical operators for the two logical qubits with and without error detection (implemented in postselection).

FIG. 3A demonstrates preparation of a 19-qubit graph state creating the |+ [symbol] _{L} logical state of the surface code. The surface code is defined by X-plaquette and Z-star stabilizers, and logical operators X_{L} (Z_{L}) are defined as strings of X (Z) products across the height (width) of the graph. To prepare this state, ancillas are moved to perform CZ gates with each of their four neighbors and are then measured, projecting the data qubits into the surface code state. The graph state stabilizers now transform into the X-plaquettes, the Z-stars (with value ±1 for a measurement outcome of ±1 of the central ancilla), and the logical X_{L} operator. Remarkably, this procedure creates a topologically ordered state in a constant-depth circuit, where measured ancilla values can be used for redefining stabilizers, which can be handled in software for practical QEC operation.

FIG. 3B shows the measured expectation values of the twelve resulting stabilizers, as well as the logical operator expectation values with/without error detection. A raw value of [symbol] X_{L} [symbol] =0.64(3) is found, with a corrected value of [symbol] X̅_̅{̅L̅}̅ [symbol] 1_{-0.01}⁺⁰ using the measured stabilizers for error detection (with 35(1)% probability of no detected errors), demonstrating preparation of this topological QEC state (see also FIG. 11, showing the expected attributes for all prepared error-protected logical states).

While surface code may be prepared with other methods, the transport capabilities provided herein enable periodic boundary conditions and realize the toric code state on a torus. To this end, the 24-qubit graph state shown in FIG. 3C is created by performing five layers of parallel gates and moving the ancillae to their separate zone for readout in a separate basis. The prepared state has seven (due to periodic boundary conditions) independent X-plaquettes and seven independent Z-stars. Moreover, due to the topological properties of this graph, two independent logical qubits can be encoded with logical operators X_{L}⁽¹⁾, Z_{L}⁽¹⁾ and X_{L}⁽²⁾, Z_{L}⁽²⁾ that wrap around the entire torus along two topologically distinct directions. Upon projective measurement of the ancilla qubits in the X-basis the toric code state |+ [symbol] _{L}⁽¹⁾|+ [symbol] _{L}⁽²⁾ is created.

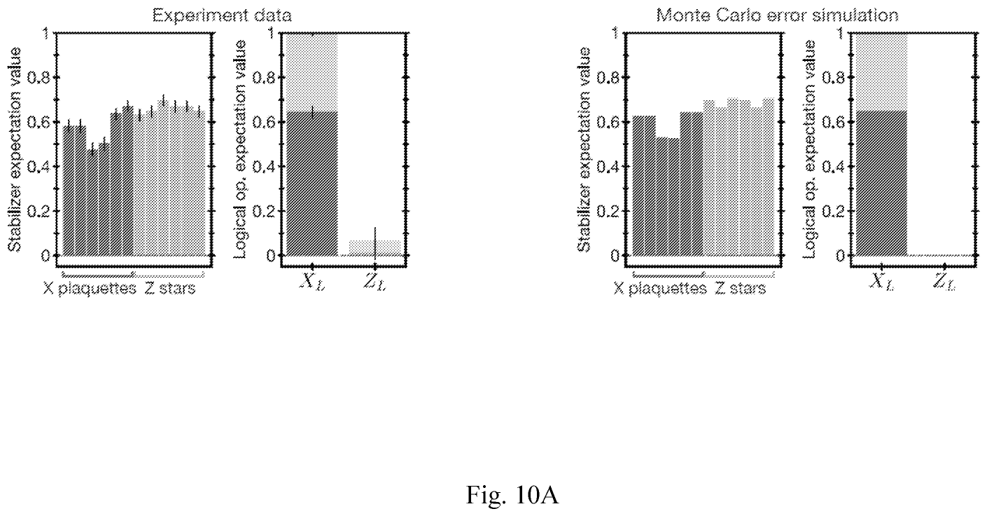

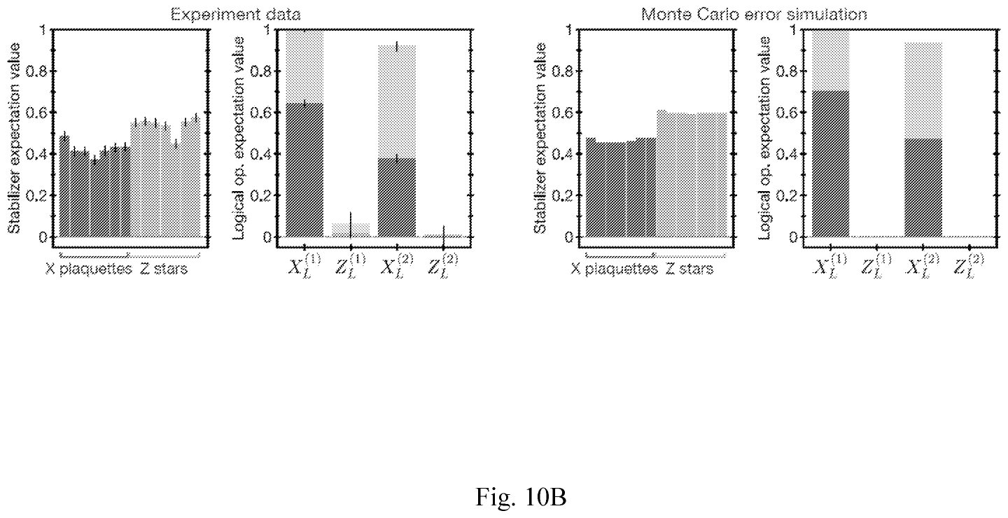

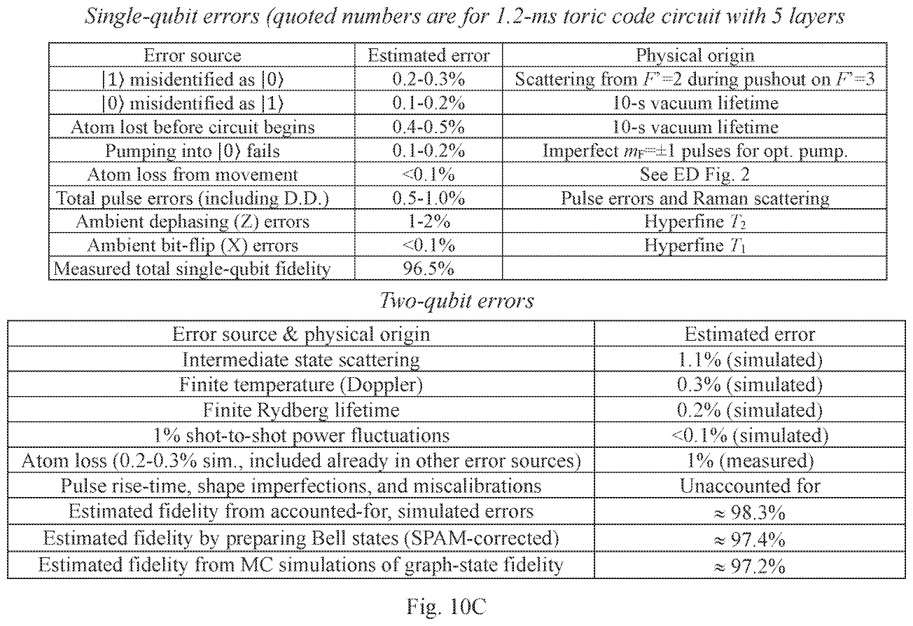

State preparation is verified in FIG. 3D by measuring the toric code stabilizers. For the two encoded logical qubits, raw logical qubit expectation values of [symbol] X_{L}⁽¹⁾ [symbol] =0.64(2), [symbol] X_{L}⁽²⁾ [symbol] =0.38(2) are found, with error-detected values [symbol] X̅_{L}⁽¹⁾ [symbol] 1_{-0.01}⁺⁰, [symbol] X̅_{L}⁽²⁾ [symbol] =0.92_{-0.03}^{+0.02} (with 20(1)% probability of no detected errors), demonstrating preparation of the toric code. The different expectation values of the corrected logical qubits originate from the aspect ratio of the torus, where X_{L}⁽¹⁾ and X_{L}⁽²⁾ are protected to distance d=4 and d=2, respectively (see also FIG. 11). The measured fidelities are in good agreement with numerical simulations of the circuit (FIG. 10), wherein each qubit experiences a per-layer error rate independent of the number of qubits or the shuttling process, indicating that errors in CZ gates (fidelity≈97.5%, Methods) constitute the dominant error source.

### Hybrid Analog-Digital Circuits

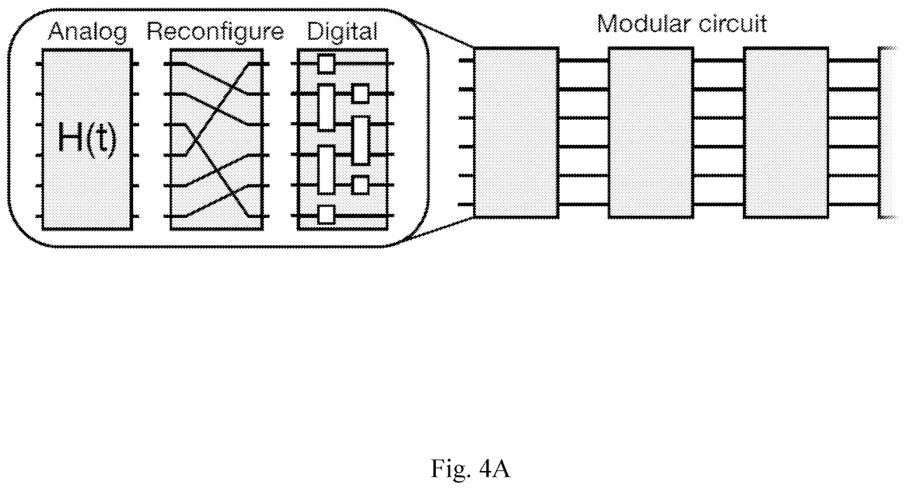

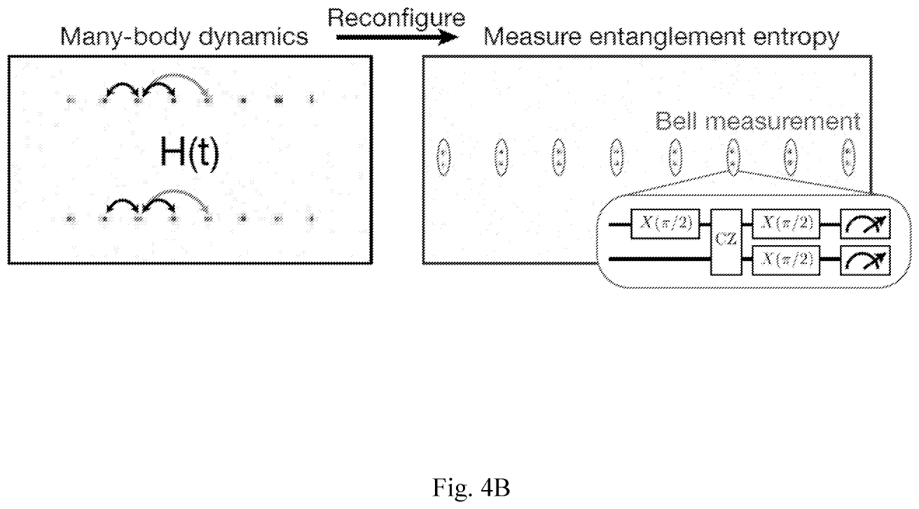

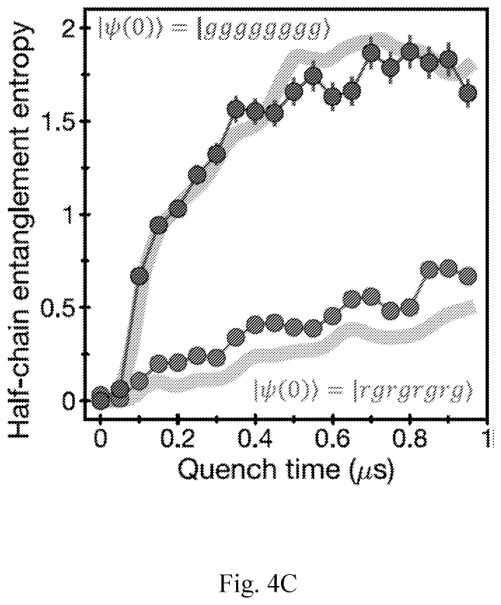

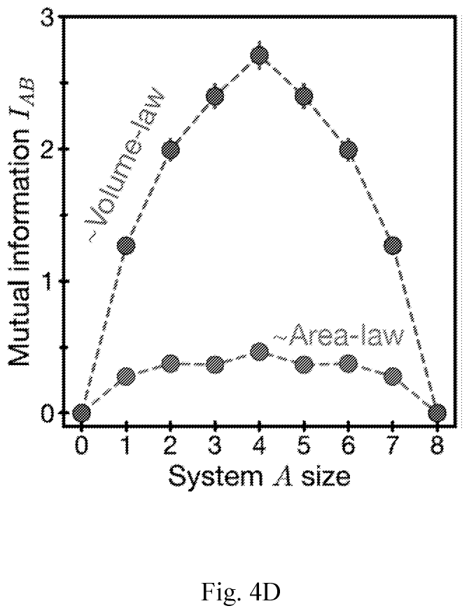

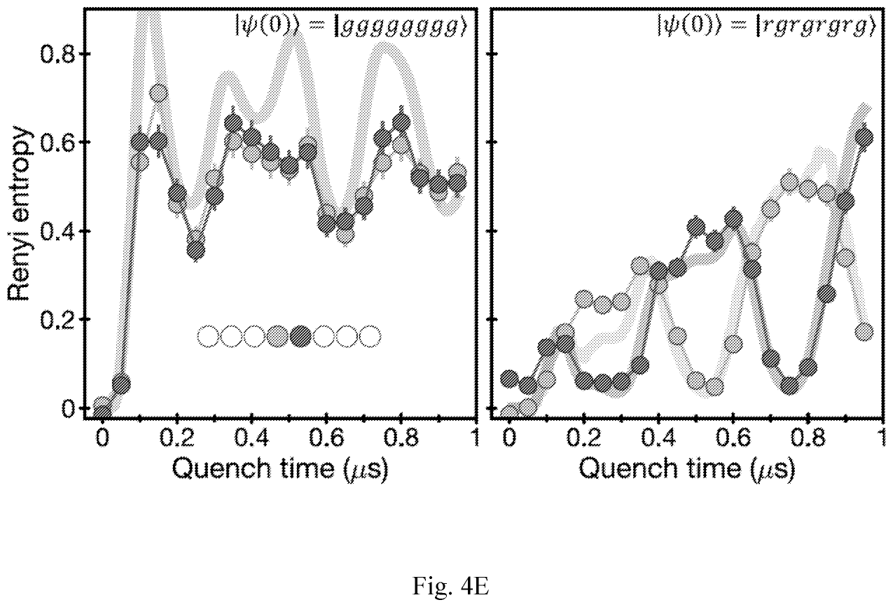

Referring to FIG. 4, dynamic reconfigurability for hybrid analog-digital quantum simulation is illustrated. FIG. 4A shows a hybrid quantum circuit combining coherent atom transport with analog Hamiltonian evolution and digital quantum gates. FIG. 4B illustrates measuring entanglement entropy in a many-body Rydberg system via two-copy interferometry. FIG. 4C shows measured half-chain Renyi entanglement entropy after many-body dynamics following quenches on two 8-atom systems. Quenching from |gggg . . . [symbol] (|g)≡|1 [symbol] ) results in rapid entropy growth and saturation, signifying quantum thermalization. Quenching from |rgrg . . . [symbol] reveals a significantly slower growth of entanglement entropy. FIG. 4D shows that measuring the mutual information at 0.5-μs quench time reveals a volume-law scaling for the thermalizing |gggg . . . [symbol] state, and an area-law scaling for the scarring |rgrg . . . [symbol] state. FIG. 4E illustrates the single-site Renyi entropies for sites in the middle of the chain quickly increase and saturate for the |gggg . . . [symbol] quench, but show large oscillations for the |rgrg . . . [symbol] quench. Solid curves are results of exact numerical simulations for the isolated quantum system under H_{Ryd} with no free parameters (see Methods for details of data processing). Error bars represent 1 standard deviation.}

Atom movement is additionally applicable to quantum simulation. In particular, the present disclosure provides for hybrid, modular quantum circuits composed of analog Hamiltonian evolution, reconfiguration, and digital gates (FIG. 4A). Together, these tools open a wide variety of new possibilities in quantum simulation and many-body physics. As a specific example, the Renyi entanglement entropy is measured after a quantum quench by effectively interfering two copies of a many-body system.

FIG. 4B illustrates the experimental procedure. After initializing both copies with all qubits in |1 [symbol] , evolve each copy is independently evolved under the Rydberg Hamiltonian H_{Ryd} for a time t, generating an entangled many-body state in the {|1 [symbol] , |r [symbol] } basis (Methods). Raman and Rydberg π pulses then map |1 [symbol] →|0 [symbol] and |r [symbol] →|1 [symbol] , transferring the entangled many-body state into the long-lived and non-interacting {|0 [symbol] , |1 [symbol] } basis. Finally, entanglement entropy is measured by rearranging the system and interfering each qubit in the first copy with its identical twin in the second copy, by use of a Bell measurement circuit. Measuring twins in the Bell basis detects occurences of the antisymmetric singlet state

$$\vert {Ψ}^{-} 〉 = \frac{\vert 01 〉 - \vert 10 〉}{\sqrt{2}} ,$$

whose presence indicates that subsystems of the two copies were in different states due to entanglement with the rest of the many-body system. Quantitatively, analyzing the number parity of observed singlets within subsystem A yields the purity Tr[ρₐ²] of reduced density matrix ρ_{A}, and thus yields the second-order Renyi entanglement entropy S₂(A)=−log₂Tr[ρ_{A}²] (Methods). This measurement circuit provides the Renyi entropy of any constituent subsystem of the whole closed quantum system, where the calculation over any desired subsystem A is performed in data processing.

This method is used to probe the growth of entanglement entropy produced by many-body dynamics (see Methods for additional benchmarking of the technique). Specifically, the evolution of two eight-atom copies under the Rydberg Hamiltonian is studied, subject to the nearest-neighbor blockade constraint. Upon a rapid quench from an initial state with all atoms in the ground state |g [symbol] ≡|1 [symbol] , it is observed that the half-chain Renyi entanglement entropy quickly grows and saturates (FIG. 4C), a process corresponding to quantum thermalization. By analyzing the Renyi mutual information I_{AB}=S₂(A)+S₂(B)−S₂(AB) between the leftmost n atoms in the chain (A) and the complement subsystem of the rightmost 8−n atoms (B), a volume-law scaling in the resulting state is found (FIG. 4D).

While such thermalizing dynamics are generically expected in strongly interacting many-body systems, remarkably, it was demonstrated previously that for certain initial states this system can evade thermalization. Underpinned by special, non-thermal eigenstates called quantum many-body scars, these states were theoretically predicted to feature dynamics associated with a slow, non-monotonic entanglement growth. FIG. 4 reports the measurement of entanglement properties of many-body scars following a rapid quench from the initial state |Z₂ [symbol] ≡|rgrg . . . [symbol] , initialized by applying local shifts within one sublattice and performing a global Rydberg π pulse (Methods). The rate of entropy growth for this initial state is significantly suppressed, and the mutual information reveals an area-law scaling (FIG. 4D). Furthermore, FIG. 4E shows the single-site entropy in the middle of the chain, demonstrating rapid growth and saturation for the thermalizing |gggg . . . [symbol] state but large oscillations for the |Z₂ [symbol] state. Remarkably, the data show that when sites of one sublattice return to low entropy, the other sublattice goes to high entropy; this reveals that the scar dynamics entangle distant atoms (of the same sublattice) while disentangling nearest neighbors, even with only nearest-neighbor interactions (see Methods). These measurements reveal nontrivial aspects of quantum many-body scars, and constitute the direct observation of exotic entanglement phenomena in a many-body system.

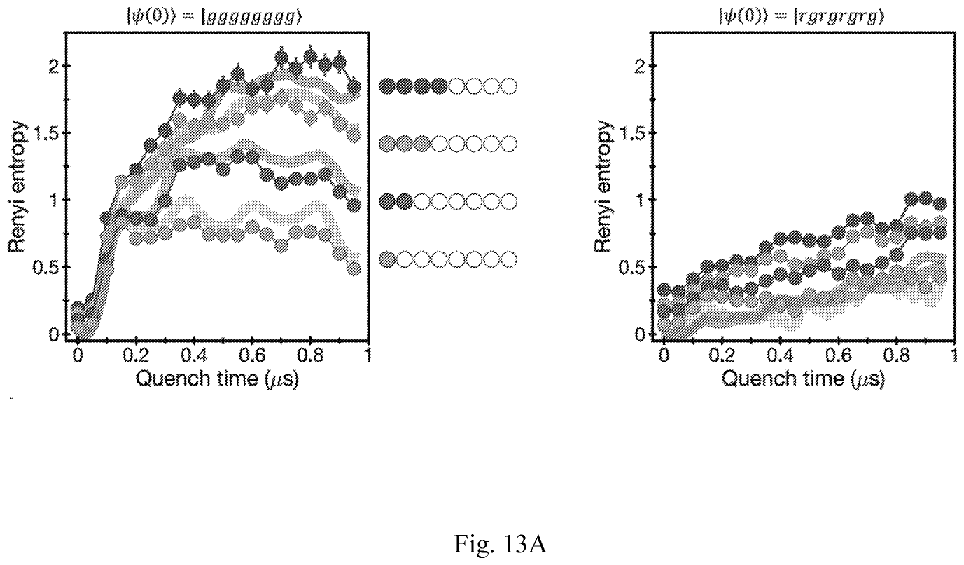

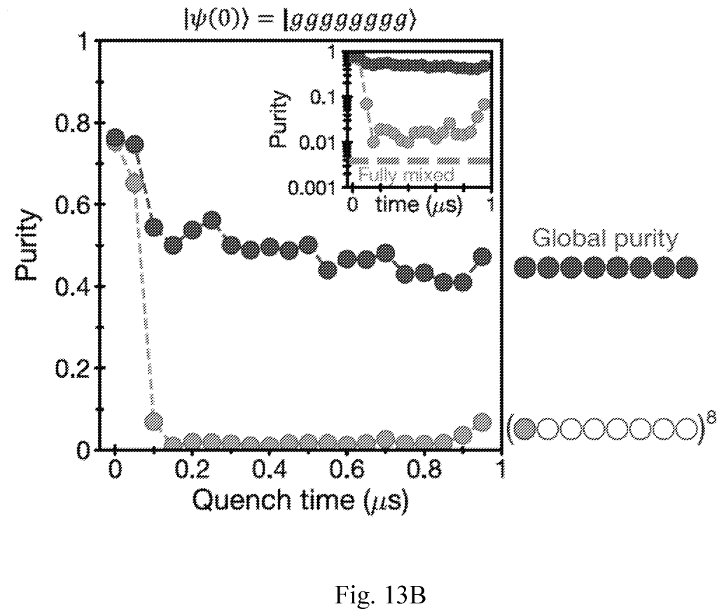

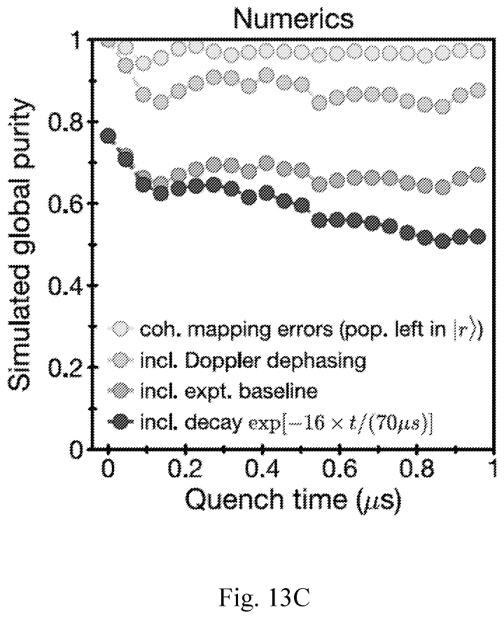

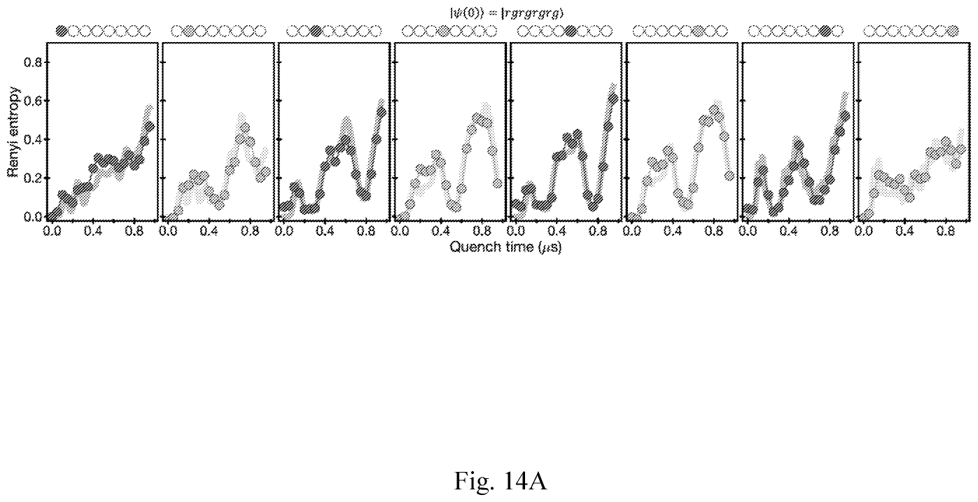

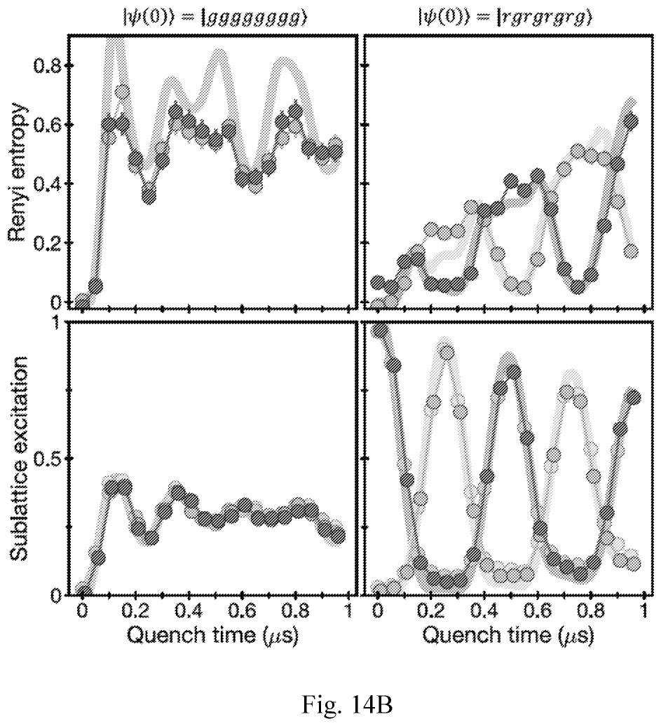

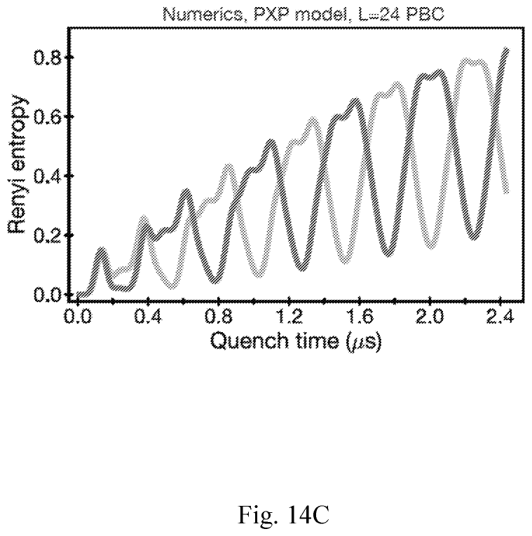

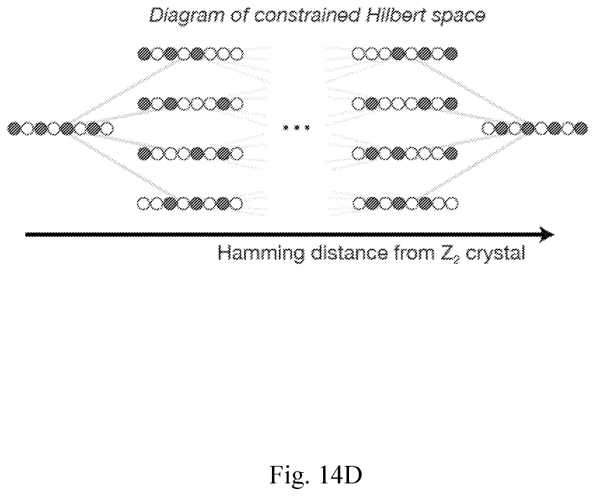

These observations are in excellent agreement with exact numerical simulations in the isolated system (lines plotted in FIGS. 4C,E and FIG. 14). Moreover, whereas the single-site purity approaches that of a fully mixed state, global purity (a 16-body observable composed of three-level systems) remains >100× that of a fully mixed state (see FIG. 13), altogether demonstrating the high accuracy and fidelity of this circuit-based technique. These results demonstrate that combining atom movement, many-body Hamiltonian evolution, and digital quantum circuits yields powerful new tools for simulating and probing quantum physics of complex systems.

### Discussion and Outlook

The experiments described herein demonstrate highly parallel coherent qubit transport and entanglement enabling a powerful quantum information architecture. The present techniques can be extended along a number of directions. Local Rydberg excitation on subsets of qubit pairs would eliminate residual interactions from unintended atoms, allowing parallel, independent operations on arrays with significantly higher qubit densities. Two-qubit gate fidelity can be improved using higher Rydberg laser power or more efficient delivery methods, as well as more advanced atom cooling. These technical improvements should allow for scaling to deep quantum circuits operating on thousands of neutral atom qubits. These upgrades can be additionally supplemented by more sophisticated local single-qubit control employing, for example, parallel Raman excitation through AOM arrays. Mid-circuit readout can be implemented by moving ancillas into a separate zone and imaging using, e.g., avalanche photodiode arrays within a few hundred microseconds.

These method has a clear potential for realizing scalable quantum error correction. For example, the procedure demonstrated in FIG. 3C can be used for syndrome extraction in a practical QEC sequence, wherein ancillas are entangled with their data qubit neighbors and then moved to a separate zone for mid-circuit readout. An entire QEC round can be implemented within a millisecond, much faster than the measured T₂>1s, and with projected fidelity improvements theoretically surpassing the surface code threshold (Methods). Such a mid-circuit readout is essential for realizing scalable fault-tolerant quantum computation. Furthermore, the ability to reconfigure and interlace arrays will allow efficient, parallel execution of transversal entangling gates between many logical qubits. In addition, these techniques also enable implementation of higher-dimensional or nonlocal error correcting codes with more favorable properties. Together, these ingredients could enable a new approach to universal, fault-tolerant quantum computing with thousands of physical qubits.

The dynamically reconfigurable architecture provided herein also opens many new opportunities for digital and analog quantum simulations. For example, the hybrid approach can be extended to probing the entire entanglement spectrum, simulating wormhole creation, performing many-body purification, and engineering novel non-equilibrium states. Entanglement transport could also empower metrological applications such as creating distributed states for probing gravitational gradients. Finally, these approaches can facilitate quantum networking between separated arrays, paving the way toward large-scale quantum information systems and distributed quantum metrology.

### Methods

### Dynamic Reconfiguration in 2D Tweezer Arrays

These experiments utilize the same apparatus described below. Inside the vacuum cell, ⁸⁷Rb atoms are loaded from a magneto-optical trap into a backbone array of programmable optical tweezers generated by a spatial light modulator (SLM). Atoms are rearranged in parallel into defect-free target positions in this SLM backbone by additional optical tweezers generated from a crossed 2D acousto-optic deflector (AOD). Following the rearrangement procedure, selected atoms are transferred from the static SLM traps back into the mobile AOD traps, and then these mobile atoms are moved to their starting positions in the quantum circuit. During this entire process, the atoms are cooled with polarization gradient cooling. Before running the quantum circuit, a camera image of the atoms in their initial starting positions is taken. Following the circuit a final camera image is taken to detect qubit states |0 [symbol] (atom presence) and |1 [symbol] (atom loss, following resonant pushout). All data are postselected on finding perfect rearrangement of the AOD and SLM atoms before running the circuit. In all experiments here, each atom remains in a single static or single mobile trap throughout the duration of the quantum circuit.

The crossed AOD system is composed of two independently controlled AODs (AA Opto Electronic DTSX-400) for x and y control of the beam positions. Both AODs are driven by independent arbitrary waveforms which are generated by a dual-channel arbitrary waveform generator (AWG) (M4i.6631-x8 by Spectrum Instrumentation) and then amplified through independent MW amplifiers (Minicircuits ZHL-5W-1). The time-domain arbitrary waveforms are composed of multiple frequency tones corresponding to the x and y positions of columns and rows, which are independently changed as a function of time for steering around the AOD-trapped atoms dynamically: the full x and y waveforms are calculated by adding together the time-domain profile of all frequency components with a given amplitude and phase for each component. For running quantum circuits, the positions of the AOD atoms at each gate location are programmed and then smoothly interpolate (with a cubic profile) the AOD frequencies as a function of time between gate positions. The cubic profile enacts a constant jerk onto the atoms, which allows movement of roughly 5-10× faster (without heating and loss) than if moving at a constant velocity (linear profile). In the movement protocol, stretches, compressions, and translations of the AOD trap array are applied: i.e., the AOD rows and columns never cross each other in order to avoid atom loss and heating associated with two frequency components crossing each other.

The AOD tweezer intensity is homogenized throughout the whole atom trajectory in order to minimize dephasing induced by a time-varying magnitude of differential light shifts. To this end, a reference camera is used in the image plane to gauge the intensity of each AOD tweezer at each gate location and homogenize by varying the amplitude of each frequency component; during motion between two locations the amplitude of each individual frequency component is interpolated.

The SLM tweezer light (830 nm) and the AOD tweezer light (828 nm) are generated by two separate, free-running Ti:sapphire lasers (M Squared, 18-W pump). Projected through a 0.5 NA objective, the SLM tweezers have a waist of roughly ˜900 nm (˜1000 nm for AODs). When loading the atoms, the trap depths are ˜2π×16 MHz, with radial trap frequencies of ˜2π×80 kHz, and when running quantum circuits the trap depths are ˜2π×4 MHz, with radial trap frequencies of ˜2π×40 KHz.

### Raman Laser System

Fast, high-fidelity single-qubit manipulations are critical ingredients of the quantum circuits demonstrated in this work. To this end, a high-power 795-nm Raman laser system is used for driving global single-qubit rotations between m_{F}=0 clock states. This Raman laser system is based on dispersive optics. 795-nm light (Toptica TA pro, 1.8 W) is phase-modulated by an electro-optic modulator (Qubig), which is driven by microwaves at 3.4 GHz (Stanford Research Systems SRS SG384) that are doubled to 6.8 GHz and amplified. The laser phase modulation is converted to amplitude modulation for driving Raman transitions through use of a Chirped Bragg Grating (Optigrate). IQ control of the SG384 is used for frequency and phase control of the microwaves, which are imprinted onto the laser amplitude modulation and thus give us direct frequency and phase control over the hyperfine qubit drive.

The Raman laser illuminates the atom plane from the side in a circularly polarized elliptical beam with waists of 40 μm and 560 μm on the thin axis and the tall axis, respectively, with a total average optical power of 150 mW on the atoms. The large vertical extent ensures <1% inhomogeneity across the atoms, and shot-to-shot fluctuations in the laser intensity are also <1%. For FIGS. 1-3, the Raman laser is operated at a blue-detuned intermediate-state detuning of 180 GHz, resulting in two-photon Rabi frequencies of 1 MHz and an estimated scattering error per π pulse of 7×10⁻⁵ (i.e. 1 scattering event per 15000 π pulses). For FIG. 4, in order to shorten the duration of the coherent mapping pulse sequence, the Raman laser power is increased and a smaller blue-detuned intermediate-state detuning of 63 GHz is employed, with a corresponding two-photon Rabi frequency of 3.2 MHz and an estimated scattering error per π pulse of 2×10⁻⁴.

### Robust Single-Qubit Rotations

For almost all single-qubit rotations in this work (other than XY8/XY 16 self-correcting sequences) implement robust single-qubit rotations are implemented in the form of composite pulse sequences. These composite pulse sequences can be highly insensitive to pulse errors such as amplitude or detuning miscalibrations. The dominant source of coherent single-qubit errors arise from ≲1% amplitude drifts and inhomogeneity across the array; as such the “BB1” (broadband 1) pulse sequence is primarily used, which is a sequence of four pulses that implements an arbitrary rotation on the Bloch sphere while being insensitive to amplitude errors to 6^{th} order. The performance of these robust pulses is benchmarked in FIG. 7A. Furthermore, by applying a train of BB1 pulses, an accumulated error consistent with the estimated scattering limit is found (not plotted here), suggesting that the scattering limit roughly represents single-qubit rotation infidelities (˜3×10⁻⁴ error per BB1 pulse due to the increased length of the composite pulse sequence). Randomized benchmarking can be applied in future studies to further study single-qubit rotation fidelity.

### Qubit Coherence and Dynamical Decoupling

In the 830-nm traps, hyperfine qubit coherence is characterized by T*₂=4 ms (not plotted here), T₂=1.5 s (XY16 with 128 total π pulses), and T₁=4 s (including atom loss) (FIGS. 7B,C). The experiments described herein are performed in a DC magnetic field of 8.5 Gauss. Coherence can be further improved by using further-detuned optical tweezers (with trap depth held constant, the tweezer differential lightshifts decrease as 1/Δ and 1/T₁ decreases as 1/Δ³) and shielding against magnetic field fluctuations. For practical QEC operation, atom loss can be detected in a hardware-efficient manner and the atom then replaced from a reservoir, which could in principle be continuously reloaded by a MOT for reaching arbitrarily deep circuits.

The transport sequences are accompanied with dynamical decoupling sequences. The number of pulses used is a tradeoff between preserving qubit coherence while minimizing pulse errors. IN various embodiments, there is an interchange between two types of dynamical decoupling sequences: XY8/XY 16 sequences, composed of phase-alternated individual π-pulses which are self-correcting for amplitude and detuning errors, and CPMG-type dynamical decoupling sequences composed of robust BB1 pulses. The CPMG-BB1 sequence is more robust to amplitude errors but incurs more scattering error. The sequence may be empirically optimized for any given experiment by choosing between these different sequences and a variable number of decoupling π pulses, optimizing on either single-qubit coherence (including the movement) or the final signal.

Typically, decoupling sequences are composed of a total 12-18 π pulses.

### Movement Effects on Atom Heating and Loss

The following discusses the effects of movement on atom loss and heating in the harmonic oscillator potential given by the tweezer trap. Motion of the trap potential is equivalent to the non-inertial frame of reference where the harmonic oscillator potential is stationary but the atom experiences a fictitious force given by F(t)=−ma(t), where m is the mass of the particle and a(t) is the acceleration of the trap as a function of time.

The average vibrational quantum number increase ΔN is given by

$$Δ N = \frac{{\vert \tilde{a} ( {ω}_{0} ) \vert}^{2}}{{( 2 {x}_{zpf} {ω}_{0} )}^{2}} \qquad Equation 1$$

where ã(ω₀) is the Fourier transform of a(t) evaluated at the trap frequency wo, and the zero point size of the particle x_{zpf}≡\sqrt{ℏ/(2mω₀)}. ΔN is the same for all initial levels of the oscillator. Experimentally, an acceleration profile a(t)=jt is applied to the atom, from time −T/2 to +T/2 to move a distance D with constant jerk j. Calculating |ã(ω)|², simplify using ω₀»T1, and assume a small range of trap frequencies to average the oscillatory terms, results in

$$Δ N = \frac{1}{2} {( \frac{\frac{6 D}{{x}_{zpf}}}{{ω}_{0}^{2} {T}^{2}} )}^{2} \qquad Equation 2$$

Several relevant insights can be gleaned from this formula. First, this expression indicates the ability to move large distances D with comparably small increases in time T. Furthermore, to maintain a constant ΔN, the movement time T∝ω₀^{-3/4}. Moreover, to perform a large number of moves k for a deep circuit, ΔN∝k/T⁴ can be estimated, suggesting that the number of moves can be increased from e.g. 5 to 80 by slowing each move from 200 μs to 400 μs. Move speed could be further improved with different a (t) profiles, but inevitably with finite resources such as trap depth, quantum speed limits will eventually prevent arbitrarily fast motion of qubits across the array.

Equation 2 is now compared to experimental observations. In FIG. 1D atom loss is observed with movement of 55 μm in 200 μs under a constant negative jerk. This speed limit is consistent with the above estimates: using ω₀=2π×40 kHz and x_{zpf}=38 nm, it is predicted that ΔN≈6 this move, corresponding to the onset of tangible heating at this move speed. More quantitatively, a Poisson distribution is assumed with mean N and variance N and integrate the population above some critical Nₘₐₓ upon which the atom will leave the trap. From this analysis, atom retention is given by

$$\frac{1}{2} ( 1 + erf [ \frac{{N}_{max} - N}{\sqrt{2 N}} ] ) .$$

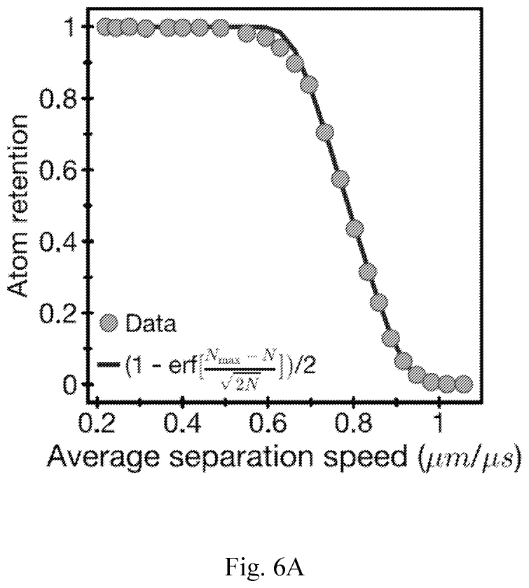

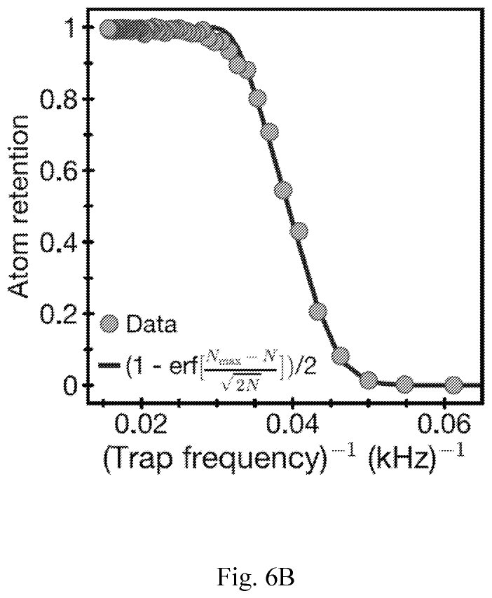

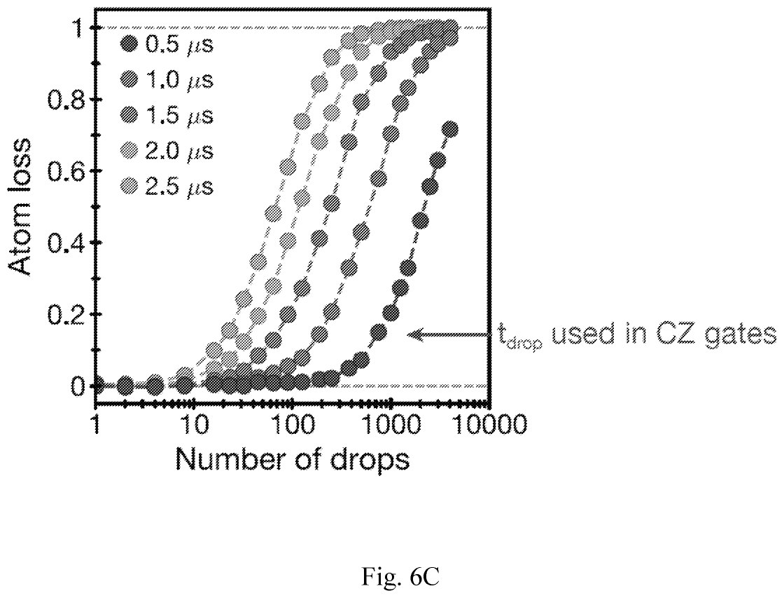

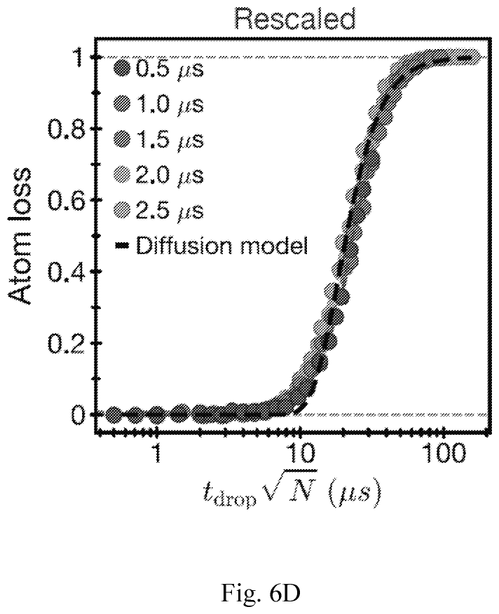

FIGS. 6A,B measure atom retention as a function of move time T and trap frequency ω₀/2π. Using the functional form above, for both sets of measurements, an Nₘₐₓ of ≈30 is extracted, corresponding to adding ≈30 excitations before exciting the atom out of the trap. Such a limit is physically reasonable as the absolute trap depth of 4 MHz implies only ≈100 levels, the atom starts at finite temperature, and moreover the effective trap frequency reduces once the anharmonicity of the trap starts to play a role. These estimates are only approximate (using an estimate ω₀ for the trap depths used during the motion), but nonetheless suggests a motion limit is consistent with physical limits for the chosen a(t). The analysis here also neglects the acoustic lensing effects associated with ramping the AOD frequency, which causes astigmatism by focusing one axis to a different plane and thus deforms the trap and reduces the peak trap intensity (and ω₀) as given by the Strehl ratio.

Additional heating and loss during the circuit can also be caused by repeated short drops for performing two-qubit gates, where the tweezers are briefly turned off to avoid anti-trapping of the Rydberg state and light shifts of the ground-Rydberg transition. However, drop-recapture measurements in FIG. 6C suggest the 500-ns drops used experimentally have a negligible effect until hundreds of drops per atom (corresponding to hundreds of CZ gates). Atom loss and heating as a function of number of drops are well-described by a diffusion model, which would then predict that reducing atom temperature by a factor of 2×(reducing thermal velocity by \sqrt{2}×) and reducing drop time t_{drop} by 2×, together would increase the number of possible CZ gates per atom to thousands.

### Two-Qubit CZ Gates Implementation

Two-qubit gates and calibrations may be implemented using the techniques provided herein. Specifically, the two-qubit CZ gate is implemented by two global Rydberg pulses, with each pulse at detuning Δ and length τ, and with a phase jump ξ between the two pulses. The pulse parameters are chosen such that qubit pairs, adjacent and under the Rydberg blockade constraint, will return from the Rydberg state back to the hyperfine qubit manifold with a phase depending on the state of the other qubit. The numerical values for these pulse parameters are:

$$Δ = - 0.377371 Ω \\ ξ = - 0.621089 \times ( 2 π ) \\ τ = 0.683201 / [ Ω / ( 2 π ) ]$$

The experiments in FIGS. 1-3 are operated with a two-photon Rydberg Rabi frequency of Ω/2π=3.6 MHz, giving a theoretical τ=190 ns and a theoretical Δ/(2π)=−1.36 MHz. The negative detuning sign is chosen to help minimize excitation into the mⱼ=+½ Rydberg state which is detuned by about 24 MHz under the field of 8.5 G (and experiences a 3×lower coupling to the Rydberg laser than the desired mⱼ=−½ state due to reduced Clebsch-Gordan coefficients). In this work strong blockade between adjacent qubits is provided, with Rydberg-Rydberg interactions V₀/2π ranging from 200 MHz to 1 GHz. In FIG. 4, Ω/2π=4.45 MHz for the two-qubit gates.

### Managing Spurious Phases During CZ Gates

The two-qubit gate induces both an intrinsic single-qubit phase, as well as spurious phases which are primarily induced by the differential light shift from the 420-nm laser. Under certain configurations, the 420-nm-induced differential light shift on the hyperfine qubit can be exceedingly large (>8M Hz), yielding phase accumulations on the hyperfine qubit of ˜6π. Small, percent-level variations of the 420-nm intensity can thus lead to significant qubit dephasing.

This 420-induced-phase issue may be addressed by performing an echo sequence: after the CZ gate, the 1013-nm Rydberg laser is turned off, a Raman π pulse is applied, and then the 420-nm laser is pulsed again to cancel the phase induced by the 420 light during the CZ gate. This method echoes out the 420-induced phase, but comes at a cost of a factor of two increase in the 420-induced scattering error, which is the dominant source of error in two-qubit CZ gates.

Echo between CZ gates. To address these various issues, a Raman π pulse is performed between each CZ gate to echo out spurious gate-induced phases on the hyperfine qubit (FIG. 5). This approach has several advantages. The 420-induced phase is now cancelled by pairs of CZ gates, without explicitly applying additional 420-nm pulses to echo each individual CZ gate, thereby reducing the scattering error of the CZ gate in this work by a factor of approximately two. This echo technique, having reduced the scattering error incurred during each gate, roughly compensates the increased scattering rate incurred by spreading optical power over more space in 2D, thereby giving comparable gate fidelites to the two-qubit CZ gate fidelities of ≥97.4(2)%. Further, the echo between CZ gates also cancels the intrinsic single-qubit phase of the CZ gate, removing errors in the calibration of this parameter, as well as canceling any other gate-induced spurious single-qubit phases such as a ˜0.01 rad phase induced by pulsing the traps off for 500 ns for the two-qubit gate (FIG. 5). In instances where the number of CZ gates is odd, the echo for the final CZ gate is performed.

Sign of intermediate-state detuning. To further suppress the effect of the spurious, 420-induced phase, the 420-nm laser is operated to be red-detuned (by 2 GHz) from the 6P_{3/2} transition. For red detunings, the light shift on the |0 [symbol] state and the |1 [symbol] state are of the same sign, minimizing the differential light shift, while for blue detunings <6.8 GHz, the light shift on the |0 [symbol] state and the |1 [symbol] state have opposite signs and amplify the differential light shift.

### Sensitivity to Axial Trap Oscillations

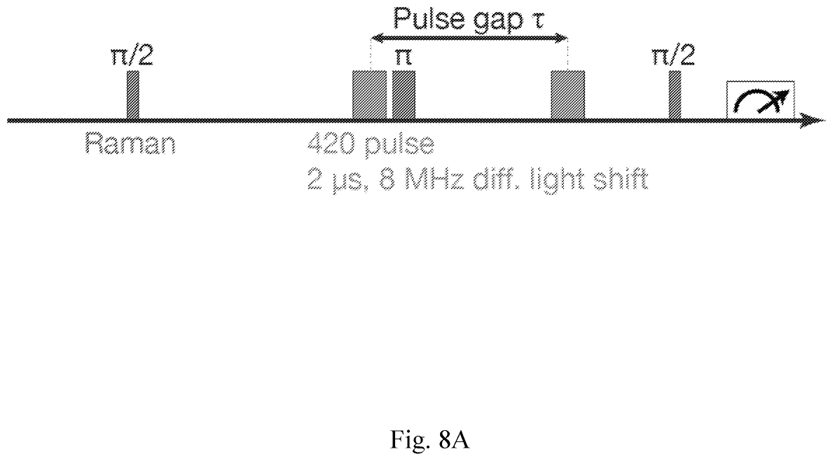

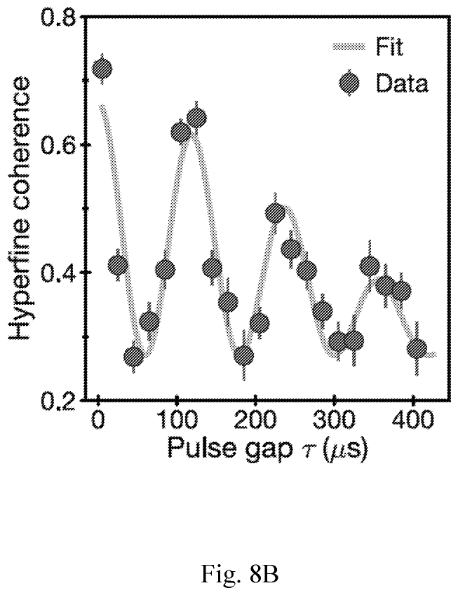

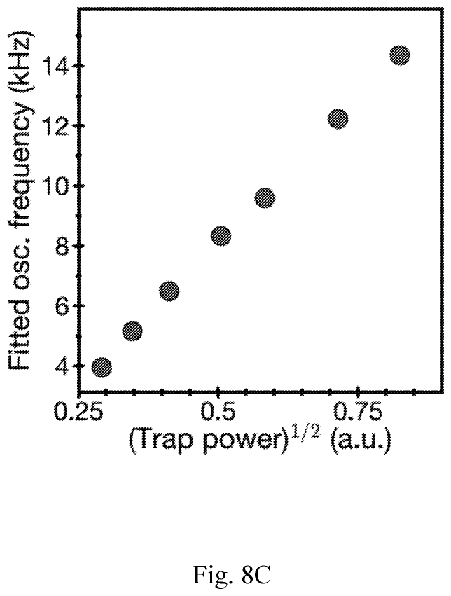

In typical Rydberg excitation timescales with optical tweezers, the axial trap oscillation frequencies of several kHz are inconsequential. Here with circuits running as long as 1.2 ms, with Rydberg pulses throughout, the axial trap oscillations can have important effects. In particular, the axial oscillations cause the atoms to make oscillations in/out of the Rydberg beams: at estimated axial temperature of ˜25 μK and axial oscillation frequency of 6 kHz, an axial spread \sqrt{ [symbol]z² [symbol]}≈1.3 μm is esimated. For 20-micron-waist beams, the effect of this positional spread is relatively small on the pulse parameters of the CZ gate, but can be significant on the sensitive 420-induced phase that should be canceled by echoing out the phase induced by CZ gates separated by ˜200 μs. When using 20-micron-waist beams, and a 2.5-GHz blue detuning of the 420-nm laser, the dephasing due to the axial trap oscillations is significant (FIG. 8). To remedy this deleterious effect, the beam waist of the 420-nm laser is increased to 35 microns (while maintaining constant intensity) and the laser frequency is changed to be 2-GHz red-detuned, together resulting in a significant reduction in the dephasing associated with improper echoing of the 420-nm pulse.

### Bell State Preparation and Fidelity

In FIG. 1, the |Φ⁺ [symbol] Bell state is prepared: after initializing a pair of qubits in |00 [symbol] , a X(π/2) pulse-CZ gate-X(π/4) pulse is applied. The raw resulting fidelity of this |Φ⁺ [symbol] Bell state as the sum of populations in |00 [symbol] and |11 [symbol] , averaged with the fitted amplitude of parity oscillations (example in FIG. 1C) which measures the off-diagonal coherences. In FIG. 1D, upon significant loss from movement, this fidelity estimate becomes skewed due to measuring an artificially large population in |11 [symbol] (since state |1 [symbol] is detected as loss); accordingly, the |Φ⁺ [symbol] population is estimated as 2×the population of |00 [symbol] once the population difference between |11 [symbol] and |00 [symbol] becomes greater than 0.1 (an arbitrary cutoff where the effects of loss start to become significant). In FIG. 1D, for moves slower than 300 μs an average raw Bell state fidelity after the moving of 94.8(2)% is achieved. In case of no move or attempt to preserve coherence for 500 μs (i.e. measuring immediately after preparing the Bell state) then a raw Bell state fidelity of 95.2(1)% is measured (not plotted here).

### Analysis of Error Sources

The following details some of the measured and estimated sources of error for an entire sequence (toric code preparation in particular, the deepest example circuit). The total single-qubit fidelity after performing the entire sequence is roughly 96.5% for the toric code circuit, which is measured by embedding the entire experiment in a Ramsey sequence: i.e., a Raman π/2 pulse is performed, all motion and decoupling is performed, and then a final π/2 pulse is performed with variable phase to measure total contrast. Single-qubit fidelity is accounted for quantitatively as being composed of known single-qubit errors in FIG. 10C.

Estimated contributions to two-qubit gate error are summarized in FIG. 10C. These estimates come from numerical simulations in QuTiP with experimental parameters. The effects of intermediate state scattering and Rydberg decay are included via collapse operators in the Lindblad master equation solver. Other error contributions include finite temperature random Doppler shifts and position fluctuations, as well as laser pulse-to-pulse fluctuations, all of which are simulated using classical Monte Carlo sampling of experiment parameters. Experimental parameters used for the simulations are as follows: blue and red Rabi frequencies (Ω_{b}, Ωᵣ)=2π×(160, 90)MHz, 6P_{3/2} intermediate state detuning=2 GHz, intermediate state lifetime=110 ns, 70S_{1/2} Rydberg state lifetime=150 μs, Rydberg blockade energy=500˜MHz, splitting to second Rydberg state=24 MHz, radial and axial trap frequencies (ωᵣ, ω_{z})=2π×(40, 6)kHz, and temperature T=20 μK. This modeling can also be used to project for future performance: by assuming a 10× increase in available 1013-nm intensity and that atoms are cooled to 2 μK temperature, a CZ gate fidelity of 99.7% is projected, beyond the surface code threshold. Alkaline-earth atoms could also offer other routes to high fidelity operations for quantum error correction.

To understand how various single-qubit and two-qubit errors contribute to graph state fidelities, a stochastic simulation of the quantum circuit used for graph state preparation is performed (FIG. 10A,B). The Clifford properties of the circuit are utilized, allowing for efficient numerical evaluation and random sampling of many possible error realizations. The simulation is performed under a realistic error model, where the rates of ambient depolarizing noise and atom loss are measured in the experiment (see FIG. 10C). The resulting stabilizer and logical qubit expectation values agree well with those measured experimentally.

### Rydberg Beam Shaping and Homogeneity

The Rydberg beams are shaped into tophats of variable size through wavefront control using the phase profile on a spatial light modulator (SLM). This ability allows matching the height of the beam profile to the experiment zone size of any given experiment, thereby maximizing the 1013-nm light intensity and CZ gate fidelities. The Rydberg beam homogeneity is optimized until peak-to-peak inhomogenities are below <1%. To this end, all aberrations are corrected up to the window of the vacuum chamber, which yields an inhomogeneity on the atoms of several percent that is attributed to imperfections of the final window. To further optimize the homogeneity, aberration corrections are tuned on the tophat through Zernike polynomial corrections to the phase profile in the SLM plane (Fourier plane). With this procedure peak-to-peak inhomogeneities are reduced to <1% over a range of 40-50 μm in the atom plane.

### Creation and Optimization of Graph Layouts

The following outlines a description of how graph layouts are optimized for the cluster state, Steane code, surface code, and toric code preparation. The optimization in this example is heuristic, and other optimal circuits may be designed through atom spatial arrangement and AOD trajectories. FIG. 9 shows exemplary graphs and the process for creating them. These are the result of optimizing on several parameters:
(1) Minimize number of parallel two-qubit gate layers.
(2) Minimize total move distance for the moving atoms.
(3) Have all moving atoms in one sublattice (all graphs realized here are bipartite) to facilitate the final local rotation of one sublattice.
(4) Minimize the vertical extent of the array and the number of distinct rows (to maximize 1013 intensity and minimize sensitivity to beam inhomogeneity between the rows).
(5) When ordering gates, apply two-qubit gates as early as possible in the circuit. If a gate layer induces a bit-flip (X error) then that error can propagate during subsequent gates (becoming a Z error on the other qubit), so gates should be in the earliest layer possible.

### Local (Sublattice) Hyperfine Rotations

Local rotations are performed in the hyperfine basis by use of the horizontally propagating 420-nm beam, which imposes a differential light of several MHz on the hyperfine qubit and can thus be used for realizing a fast Z rotation. To realize the local Y(π/2) rotation used throughout this work, one sublattice of atoms is moved out of the 420-nm beam, then the following pulses are applied [global Y(π/4)]−[local Z(x)]−[global Y(π/4)]. This realizes a Y(π/2) rotation on one sublattice and a Z(π) rotation on the other sublattice (which is inconsequential as it then commutes with the immediately following measurement in the Z-basis). To apply a Y(π/2) on the other sublattice of atoms, an additional global Z(π) is added (implemented by jumping the Raman laser phase) between the two Y(π/4) pulses. Additional locally focused beams may be provided for performing local Raman control of hyperfine qubit states. However, moving atoms works so efficiently (even for moving>50 μm to move out of the 420-nm beam) that this approach is well-suited for producing a high-fidelity, homogeneous rotation on roughly half the qubits.

### Local Rydberg Initialization

Local Rydberg control is performed in order to initialize the | [symbol] ₂ [symbol] =|rgrg . . . [symbol] =|r1r1 . . . [symbol] state for studying the dynamics of many-body scars. This local initialization is achieved by applying ˜50 MHz light shifts between |1 [symbol] and |r [symbol] using 810-nm tweezers generated by an SLM onto a desired subset of sites, and then applying a global Rydberg π pulse which excites the non-lightshifted atoms. Every other atom in each chain is thus prepared into |r [symbol] , but since the locations of the SLM tweezers are fully programmable, this technique can be used to prepare any initial blockade-satisfying configuration of atoms in |1 [symbol] and |r [symbol] .

The 50 MHz biasing light shift is significantly larger than the Rydberg Rabi frequency Ω/2π=4.45 MHz, leading to a Rydberg population on undesired sites of <1%. The t=0 time point of FIG. 14B shows the high-fidelity preparation of the | [symbol] ₂ [symbol] state using this approach. With 810-nm light, even though the achieved biasing light shift is significant, the Raman-scattering-induced T₁ (of the hyperfine qubit) is still ˜50 ms and thus leads to a scattering error ≲4×10⁻⁶ during the 200-ns pulse of the light-shifting tweezers. There can also be a motional effect from the biasing tweezers, with an estimated radial trapping frequency of 150 kHz, which is negligible during the 200-ns pulse.

### Rydberg Hamiltonian

In FIG. 4, dynamics under the many-body Rydberg Hamiltonian in Equation 3 are considered.

$$\frac{{H}_{Ryd}}{ℏ} = \frac{Ω}{2} {\sum }_{i} {σ}_{i}^{x} - Δ {\sum }_{i} {n}_{i} + {\sum }_{i < j} {V}_{ij} {n}_{i} {n}_{j} \qquad Equation 3$$

In Equation 3, ℏ is the reduced Planck constant, Ω is the Rabi frequency, Δ is the laser frequency detuning, nᵢ=|rᵢ [symbol] [symbol] rᵢ| is the projector onto the Rydberg state at site i and σᵢ^{x}=|1ᵢ [symbol] [symbol] rᵢ|+|rᵢ [symbol] [symbol] 1ᵢ| flips the atomic state. For the entanglement entropy measurements in this work, lattice spacings are chosen where the nearest-neighbor (NN) interaction V₀>Ω results in the Rydberg blockade, preventing adjacent atoms from simultaneously occupying |r [symbol] . In particular, the many-body experiments are performed on 8-atom chains, quenching to a time-independent H_{Ryd} with V₀/2π=20 MHz, Ω/2π=3.1 MHz, Δ/2π=0.3 MHz. Quenching to small, positive Δ=0.0173˜V₀ partially suppresses the always-positive long-range interactions and thereby is optimal for scar lifetime, as derived and shown experimentally.

### Coherent Mapping Protocol

A coherent mapping protocol is provided to transfer a generic many-body state in the {|1 [symbol] , |r [symbol] } basis to the long-lived and non-interacting {|0 [symbol] , |1 [symbol] } basis. To achieve this mapping, immediately following the Rydberg dynamics, a Raman π pulse is applied to map | 1 [symbol] →|0 [symbol] , and then a subsequent Rydberg π-pulse to map |r [symbol] =>|1 [symbol] .

Even for perfect Raman and Rydberg It pulses (on isolated atoms), there are three key sources of infidelity associated with this mapping process:
(1) Any population in blockade-violating states (i.e., two adjacent atoms both in |r [symbol] ) will be strongly shifted off-resonance for the final Rydberg π pulse. As such, this atomic population will be left in the Rydberg state and lost.
(2) Long-range interactions, e.g., from next-nearest-neighbors, will detune the final Rydberg π pulse from resonance and thus reduce pulse fidelity. Since the long-range interactions are not the same for all many-body microstates, this effect cannot be mitigated by a simple shift of the detuning.
(3) Dephasing of the state occurs throughout the duration of the Raman π pulse, predominantly from Doppler shifts between the ground states |0 [symbol] , |1 [symbol] and the Rydberg state |r [symbol] . Although these random on-site detunings are also present during the many-body dynamics, turning the Rydberg drive Ω off allows the system to freely accumulate phase and makes us particularly sensitive to dephasing errors.

The above error mechanisms are mitigated as follows. To minimize errors from (1), many-body dynamics are performed with

$$\frac{{Ω}^{2}}{2 {V}_{0}^{2}} \approx 0.01 .$$

This minimizes the probability of an atom to violate blockade to be of order 1%. To help minimize errors from (2), the amplitude of the 420-nm laser is increased for the final π pulse by a factor of 2×, such that

$${( \frac{{V}_{NNN}}{Ω} )}^{2} = 0.005$$

(where V_{NNN} are the interactions with next-nearest neighbors), reducing pulse errors from long-range interactions to order 1%. Finally, to reduce errors from (3), a fast Raman π pulse is performed, leaving only 150 ns between ending the many-body Rydberg dynamics and beginning the Rydberg π pulse. The 150-ns gap is comparably short relative to the T*2_{≈3}-4 μs of the {|g [symbol] , |r [symbol] } basis, leading to a random phase accumulation of order ˜0.02×2π rad per particle, but is further compounded by having entangled states of N particles in one copy accumulating a random phase relative to entangled states of N particles in the second copy. These various effects are discussed numerically in FIG. 13C.

The global Raman beam induces a light-shift-induced phase shift of ≈π on |0 [symbol] , |1 [symbol] relative to |r [symbol] during the Raman π pulse. Similarly, the global 420-nm laser also induces a light-shift-induced phase shift of ≈π between |0 [symbol] and |1 [symbol] during the Rydberg π pulse. While the measurements performed here are interferometric (in other words, the singlet state measured is invariant under global rotations) and thus not affected by these global phase shifts, these phase shifts can be measured and accounted for where relevant.

### Measuring Entanglement Entropy

The second-order Renyi entanglement entropy is given by S₂(A)=−log₂Tr[ρ_{A}²], where Tr[ρ_{A}²] is the state purity of reduced density matrix ρ_{A} on subsystem A. The purity can be measured with two copies by noticing that Tr[ρ_{A}²]=Tr[Ŝρ_{A}⊗ρ_{A}] is the expectation value of the many-body SWAP operator Ŝ. The many-body SWAP operator is composed of individual SWAP operators ŝᵢ on each twin pair, i.e. Ŝ=Πᵢŝᵢ (with i∈A). Measuring this expectation value amounts to probing occurences of the singlet state

$$\frac{\vert 01 〉 - \vert 10 〉}{\sqrt{2}}$$

(with eigenvalue −1 under ŝᵢ), as all other si eigenstates have eigenvalue +1. Occurences of the singlet state in each twin pair, i.e. the Bell state |ψ⁻ [symbol] , is extracted by a Bell measurement circuit (with an additional local Z(π), see next paragraph) which maps |ψ⁻ [symbol] →|00 [symbol] and can thereafter be measured in the computational basis. As such, after performing the Bell measurement circuit, the resulting bit string outputs are analyzed and the purity of any subsystem A is determined by calculating [symbol] Π_{i∈A}ŝᵢ [symbol] : i.e., purity is measured as the average parity= [symbol] (−1)^{observed|00} [symbol] ^{pairs} [symbol] within A. In the absence of experimental imperfections, the purity will equal 1 for the whole system, and be less than 1 for subsystems which are entangled with the rest of the system.

A Bell measurement circuit can be decomposed into applying an X(π/2) rotation on one atom of the twin pair, then applying a CZ gate, and then a global X(π/2) rotation. In other measurements a local X(π/2) is realized by doing a global X(π/4) rotation, then local Z(π) rotation, and then global X(π/4). However, for this singlet measurement circuit, the first X(π/4) is redundant as the singlet state is invariant under global rotations, and so for the local X(π/2) only the local Z(π) and then the second global X(π/4) are applied. This effectively realizes the X(π/2) on one qubit, up to a Z(π) on the other qubit (not shown in circuit diagram in FIG. 4). Under this simplification, the Bell measurement circuit to map |ψ⁻ [symbol] →|00 [symbol] can be roughly understood as the reverse of the Bell state preparation circuit, which is precisely how the parameters of the Bell measurement are calibrated.

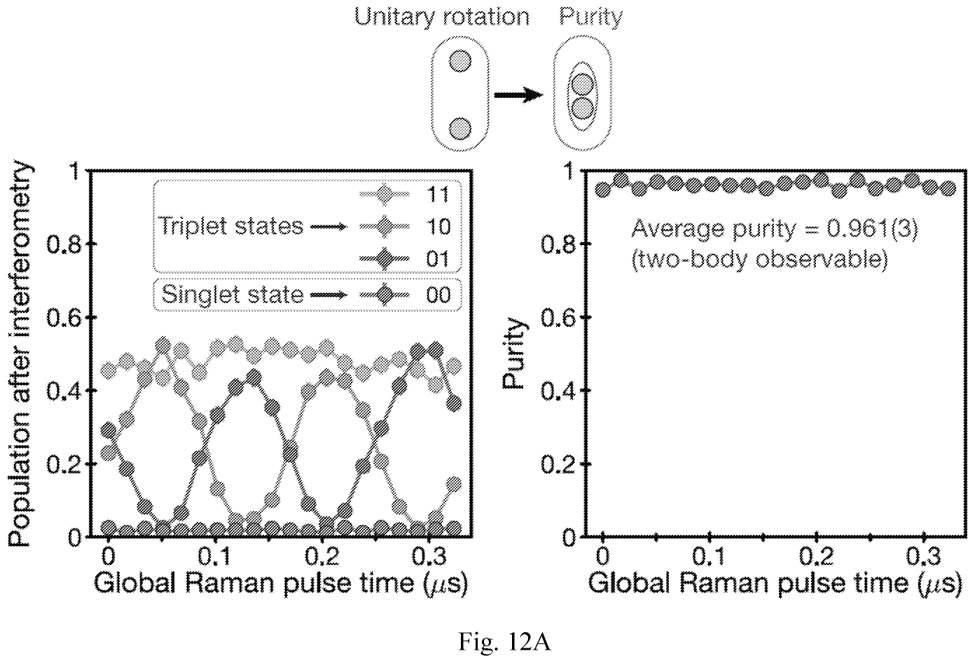

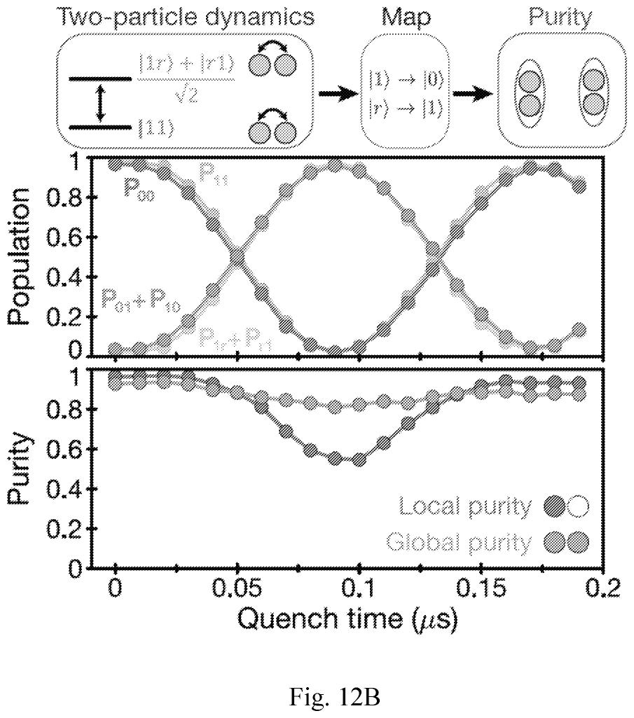

Calibrating and benchmarking the interferometry. To validate the interferometry measurement (and check for proper calibration), it is benchmarked separately from the many-body dynamics and coherent mapping protocol. This benchmarking is performed by preparing independent qubits in identical, variable single-qubit superpositions (through a global Raman pulse of variable time) and ensuring that the interferometry rarely results in |00 [symbol] for all the variable initial product states (FIG. 12A). This is an important benchmarking step, because small miscalibrations of the Bell measurement can lead to lower fidelity (i.e. higher entropy) for different initial product states and thereby result in additional spurious signals in an entanglement entropy measurement. This measurement is particularly sensitive to the single-qubit phase immediately before the final X(π/2) pulse (induced by the CZ gate and cancelled by a global Z(θ) pulse).

### Additional Many-Body Data and Details

To benchmark the method of measuring entanglement entropy in a many-body system, in FIG. 12B the entanglement dynamics are examined after initializing two proximal atoms in |1 [symbol] and resonantly exciting to the Rydberg state for a variable time t. Under conditions of Rydberg blockade, this excitation results in two-particle Rabi oscillations between |11 [symbol] and the entangled state

$$\vert W 〉 = \frac{1}{\sqrt{2}} ( \vert 1 r 〉 + \vert r 1 〉 )$$

(top panel of FIG. 12B). The state purity of this two-particle system is measured by performing Bell measurements on atom pairs from two identical copies. Locally, the measured purity of the one-particle subsystem reduces to a value of ≈0.5 when the system enters the maximally entangled |W [symbol] state, at which point the reduced density matrix of each individual atom is maximally mixed. In contrast, the purity of the global, two-particle state remains high. The observation that the global state purity is higher than the local subsystem purity is a distinct signature of quantum entanglement.

For the data shown in FIGS. 4C and 4E, the data is subtracted by an extensive classical entropy. This fixed, time-independent offset is given by the entropy-per-particle, i.e. (global entropy at quench time t=0)×(subsystem size)/(global system size). In FIG. 13A the raw entanglement entropy measurements are shown alongside numerics, to indicate the size of the extensive classical entropy contribution. In plotting, the theory curves are delayed by 10 ns to account for the fact that the Raman π pulse cuts off the final 10 ns of the Rydberg evolution, which is done to keep the coherent mapping gap as short as possible and minimize Doppler dephasing. Further, in FIG. 13B the measured global purity is plotted and compared to numerical simulations incorporating experimental errors (FIG. 13C).

In FIG. 14 additional many-body data are shown on the 8-atom chain system, with the same parameters as those used in the main text. The measured single-site entropy of each site is shown in the 8-atom chain for the | [symbol] ₂ [symbol] quench in FIG. 14A. Furthermore, in FIG. 14B the global Rydberg population is plotted, measured in both the {|1 [symbol] , |r [symbol] } and {|0 [symbol] , |1 [symbol] } bases.

Referring to FIG. 5, a CZ gate echo, atomic level structure, and typical pulse sequence are illustrated. As shown in FIG. 5A, the two-qubit gates, in addition to applying a controlled-Z operation between the two qubits, also induce a single-qubit phase Z(ζ) to both qubits, composed of the intrinsic phase of the CZ gate and additional spurious phases from the 420-nm Rydberg laser and pulsing the traps off. Since all gates are applied in parallel by global pulses of the Rydberg laser, if a qubit is not adjacent to another qubit, it does not perform a CZ gate but still acquires the same Z(ζ) (identical to being adjacent to another qubit in state |0 [symbol] , which is dark to the Rydberg laser). As diagrammed, the additional, undesired Z(ζ) is canceled by applying a n pulse between pairs of CZ gates. This echo procedure removes any need to calibrate the intrinsic phase from the CZ gate, and renders us insensitive to any spurious changes in Z(ζ) slower than ˜200 μs. The additional Y(π) propagates in a known way through the CZ gates and multiplies certain stabilizers by a −1 sign, which simply redefines the sign of stabilizers and logical qubits. FIG. 5B is a level diagram showing key ⁸⁷Rb atomic levels used. The Rydberg excitation scheme from |1 [symbol] to |r [symbol] is composed of a two-photon transition driven by a 420-nm laser and a 1013-nm laser. A DC magnetic field of B=8.5G is applied throughout this work. FIG. 5C is a schematic of an exemplary pulse sequence for running a quantum circuit.

Referring to FIG. 6, movement characterization and multiple drop-recaptures are illustrated. In FIG. 6A, atom retention is given as a function of average separation speed 2D/T (as is plotted in FIG. 1D for separating Bell pairs), with subtracted background loss of 0.7%. The inset in FIG. 1D is normalized by (Atom retention)² (without subtracting background loss). The dark curve is calculated using experimental parameters and Equation 2, matched to the experimental data by setting Nₘₐₓ=26 and averaging over a range of ω₀/2π of ±15% around an average

$$\frac{{ω}_{0}}{2 π} = 40 kHz .$$

In FIG. 6B, atom retention is given as a function of inverse trap frequency (2π/ω₀) after the four moves of the surface code Wo circuit. For calculating the atom loss here Nₘₐₓ=33 and average the trap frequencies over a range of ±15%. These quantitative estimates are sensitive to ω₀ which is roughly estimated. In FIG. 6C, Atom loss as a function of drop time and number of drop loops, with 100 μs wait between each drop. When running quantum circuits 500-ns drops are used for each CZ gate (to avoid anti-trapping of the Rydberg state and light shifts of the transition), for which hundreds of drops can be made (corresponding to hundreds of possible CZ gates per atom) before atom loss becomes significant. In FIG. 6D, by rescaling the x-axis of the data to t_{drop}\sqrt{N}, it is shown that the data of the various t_{drop} collapse onto a universal curve, suggesting a diffusion model for explaining the atom loss after a certain number of drops. By modeling such a diffusion process analytically the black curve is obtained with a temperature of 10 μK and a trapping radius of 1 μm.

Referring to FIG. 7, robust single-qubit control and qubit coherence are illustrated. In FIG. 7A, robust BB1 single-qubit rotation is compared to a normal single-qubit rotation, as a function of pulse area error. An arbitrary BB1 (θ, ϕ) rotation on the Bloch sphere of angle θ about axis ϕ is realized with a sequence of four pulses:

$${( π )}_{φ + ϕ} {( 2 π )}_{3 φ + ϕ} {( π )}_{φ + ϕ} {( θ )}_{ϕ} , where φ = {cos}^{- 1} ( - \frac{θ}{4 π} ) .$$

Pulse fidelity is measured here for a π pulse, defined such that the fidelity is the probability of successful transfer from |0 [symbol] →|1 [symbol] , including SPAM correction. FIG. 7B illustrates preserving hyperfine qubit coherence using dynamical decoupling (XY 16 with 128 total π pulses). Qubit coherence is observed on a timescale of seconds, with a fitted coherence time T₂=1.49(8)s. Data is measured with either a +π/2 or −π/2 pulse at the end of the sequence, and these curves are then subtracted to yield the coherence y-axis. In FIG. 7C, hyperfine qubit T₁, measured by the difference of final F=2 populations between measurements starting in |F=2, m_{F}=0 [symbol] and |F=1, m_{F}=0 [symbol] . Atom loss without cooling is separately measured (predominantly arising from vacuum loss) and normalized to also measure the intrinsic spin relaxation time T′₁ in the absence of atom loss. All data here is measured in 830-nm traps.

Referring to FIG. 8, the effect of axial trap oscillations on echo fidelity of 420-nm Rydberg pulse is illustrated. FIG. 8A illustrates noise correlation measurement of the 420-nm Rydberg laser pulse intensity. In the blue-detuned configuration used in this figure only, the 420-nm laser induces an 8 MHz differential light shift on the hyperfine qubit, and consequently a phase accumulation of 32π during a 2-μs pulse (the CZ gates are 400-ns total). Small fluctuations of the 420-nm laser intensity lead to large fluctuations in phase accumulation of the hyperfine qubit, and thus cause significant dephasing. The echo sequence diagrammed here probes the correlation of the accumulated phase between two 420-nm pulses separated by a variable time T, and thus informs how far-separated in time the 420-nm pulses can be while still properly echoing out fluctuations in the 420-nm intensity. FIG. 8B is a graph of hyperfine coherence (a proxy for echo fidelity) versus gap time t between the two 420-nm pulses. The echo fidelity decreases initially due to a decorrelation of the 420-nm intensity, but then increases again, showing that the correlation of the 420-nm intensity is non-monotonic. The decaying oscillations are fit to a functional form of

$$y = {y}_{0} + A {cos}^{2} ( π f τ ) exp [ - {( \frac{τ}{T} )}^{2} ] .$$

FIG. 8C is a graph of fitted oscillation frequency f of the correlation/decorrelation of the noise follows a square-root relationship with the trap power, and is consistent with the expected axial trap oscillation frequency. These observations indicate that a significant portion of the correlation/decorrelation of the 420-nm noise arises from the several-μm axial oscillations of the atom in the trap. For this measurement, the 420-nm beam is intentionally displaced by several μm in order to place the atom on a slope of the beam, increasing sensitivity to this phenomenon. For other experiments, minimize sensitivity to these effects is minimized by operating in the center of a larger (35-micron-waist) 420-nm beam and operating red-detuned of the intermediate-state transition.

Referring to FIG. 9, exemplary movement schematics are provided. Schematics show the gate-by-gate creation of (FIG. 9A) the 1D cluster state, (FIG. 9B) the Steane code, (FIG. 9C) the surface code, and (FIG. 9D) the toric code, in a side-by-side comparison. These various graph states are all generated in the same way, and encoding a desired circuit is a matter of positioning the atoms in different initial positions and applying an appropriate AOD waveform. To realize a desired circuit, atom layouts and trajectories are optimized heuristically in the way described in the Methods text. FIG. 9C also shows the definition of surface code stabilizers.

Referring to FIG. 10, error simulations and tabulated single-qubit and two-qubit error estimates are provided. The measured graph state fidelities are compared to those from a stochastic Monte Carlo simulation for (FIG. 10A) the surface code and (FIG. 10B) the toric code. The simulated stabilizers agree well with the experimental data for this empirical depolarizing noise model. In addition, for the surface code (toric code) in the experiment 35% (20%) of measurements detect no stabilizer errors, compared to 40% (26%) in the simulation. Two-qubit errors are described by rates of 0.2% Y error, 0.2% X error, 0.5% Z error, and 0.5% loss per qubit per parallel layer (4 layers for surface code, 5 layers for toric code), corresponding to a 97.2% CZ-gate fidelity. Ambient, single-qubit errors are at a rate of 0.1% Y error, 0.1% X error, 0.4% Z error, and 0.2% loss per qubit per parallel layer, as well as an initial 1% loss before the circuit begins (empirically factoring in SPAM errors). FIG. 10C provides a tabulation of single-qubit (SQ) and two-qubit (TQ) gate errors that are measured, estimated, and extrapolated. Simulated TQ fidelities include the 0.6% scattering error from the 420-nm echo pulse. The estimated TQ fidelities are given for the experiments of the surface code and toric code, but is an underestimate of the TQ fidelities for the cluster state and Steane code measurements where the 1013-nm intensity is increased by 2× and the 420-nm intensity is reduced by 2×, increasing gate fidelity. The Bell state estimate of CZ gate fidelity is similarly done with 2× higher 1013 intensity, but includes the 420-nm echo pulse, and consequently yields a similar gate fidelity as the surface and toric code estimates.

Referring to FIG. 11, properties of encoded logical states are illustrated. FIG. 11A provides a summary of logical error probabilities for the various error correcting graphs made in this work (all in logical state |+ [symbol] _{L}), for raw measurements as well as implementing error correction and error detection in postprocessing. Error correction for the Steane code is implemented with the Steane code decoder and is implemented with the minimum-weight-perfect-matching algorithm for the surface and toric codes. For the even-distance toric code, when correction is ambiguous, the logical qubit is not flipped, and accordingly the distance d=2 logical qubit does not change under the correction procedure. The observed fidelities are comparable to similar demonstrations in state-of-the-art experiments with other platforms. FIG. 11B shows the lifetime of the logical |+ [symbol] _{L} state on the surface code, with correction and detection performed in postprocessing as in FIG. 11A. After state preparation, the |+ [symbol] _{L} state is held for a variable time before projective measurement, with two π pulses applied for dynamical decoupling (lifetime can be extended significantly further by applying e.g. 128 π pulses as done in FIG. 7B). Some experimental parameters are slightly different here compared to those in FIG. 11A, hence the higher error rates here at the time 0 point. FIG. 11C shows a logical π/2 rotation on the Steane code to prepare logical qubit state |0 [symbol] _{L}. The Steane code, surface code, and toric code all have transversal single-qubit Clifford operations on the logical qubit (including in-software rotations of the lattice), which is a high-fidelity operation in the system since the transveral rotations are implemented in parallel with the global Raman laser and the physical single-qubit fidelities are high. A logical π/2 rotation is shown here for the Steane code as an example but the various basis states along the cardinal axes of the logical Bloch sphere can be realized for all of these codes.

Referring to FIG. 12, benchmarking of the interferometry measurement is illustrated. To benchmark the gate-based interferometry technique, variable single-particle pure states are prepared (by applying a variable-length resonant Raman pulse) and then the system is reconfigured and the interferometry circuit is applied on twin pairs. The interferometry circuit converts the anti-symmetric singlet state |ψ⁻ [symbol] to the computational basis state |00 [symbol] , while converting the symmetric triplet states to other computational states. The resulting twin pair output states are plotted in the left panel. The |00 [symbol] state is rarely observed (1.95(2)% of measurements), with a measurement fidelity independent of the initial state. This low probability P₀₀ of observing |00 [symbol] corresponds to a high extracted single-particle purity of 2P₀₀−1=0.961(3) (FIG. 12A, right panel). This measurement is a useful benchmark, as interferometry miscalibrations can result in significant state-dependence of the observed purity that would then compromise the validity of the many-body entanglement entropy measurement. Benchmarking the entanglement entropy measurement with Bell state arrays. (FIG. 12B, Top) Microstate populations during two-particle oscillations between |11 [symbol] and

$$\frac{1}{\sqrt{2}} ( \vert 1 r 〉 + \vert r 1 〉 )$$

under a Kydberg pulse of variable duration. Faint lines show measurement results in the {|1 [symbol] , |r [symbol] } basis, and dark lines show results in the {|0 [symbol] , |1 [symbol] } basis after the coherent mapping process. (FIG. 12B, Bottom) Measured local and global purities by analyzing the number parity of observed |00 [symbol] twin pairs in each measurement. For this two-particle data, a gap of 230 ns is used in the coherent mapping sequence as opposed to the 150-ns gap used in the many-body data.

Referring to FIG. 13, raw many-body data and numerical modeling of errors is provided. FIG. 13A shows raw measured Renyi entropy without subtracting the extensive classical entropy, as a function of subsystem size for quenches from |rgrgrgrg [symbol] and |gggggggg [symbol] . The Renyi entropy of the 4-atom subsystem is the same underlying data as the half-chain entanglement entropy plotted in FIG. 4D. In prior examples, the data was subtracted by a fixed offset given by the classical entropy-per-particle, corresponding to the time=0 offset for each subsystem size. The extensive, classical entropy offset is slightly larger for the |rgrgrgrg [symbol] quench due to non-unity fidelities both of preparing |r [symbol] and mapping |r [symbol] →|1 [symbol] . FIG. 13B shows raw global purity after the |gggggggg [symbol] quench. The global purity is a sensitive proxy for the fidelity of the entire process. This 16-body observable, composed of three-level systems, remains>100×the purity expected for a fully mixed state of 8 qubits (½⁸) (see inset). For comparison of scale single-particle purity is also plotted to the 8^{th} power, to indicate what the global purity would be if the measurement results on each twin were uncorrelated. FIG. 13C shows global purity for the 8-atom quench calculated through numerical modeling of the three-level system {0 [symbol] |1 [symbol] ≡|g [symbol] , |r [symbol] } with a variety of simulated error sources. The experimentally measured purity is modeled by calculating the expectation value of the SWAP operator in the {|0 [symbol] , |1 [symbol] } basis between two independent chains, taking into account that residual population in |r [symbol] results in atom loss and measurement associated with the +1 eigenvalue of the SWAP operator (as the twin state |00 [symbol] can no longer be detected). The top curve includes only errors from population left in |r [symbol] following the coherent mapping step (see methods text). The second-from-top curve includes single-site dephasing (T*₂ during the Rydberg dynamics and the coherent mapping gap, modeled by a random on-site detuning which is Gaussian-distributed with zero mean and standard deviation of 100 kHz. The third and fourth curves include multiplication by the experimentally observed raw global purity at quench time t=0, and then further multiplying empirically by an exponential decay exp[−16×t/(70 μs)] as a simple model for scattering and decay errors with an experimentally estimated rate of roughly 70 μs for each of the 16 atoms between the two chains.

Referring to FIG. 14, local observables and entanglement entropy for quantum many-body scars are illustrated. FIG. 14A shows experimentally measured single-site entropy for each site in the 8-atom chain when quenching from the scarred | [symbol] [symbol] state, including the classical entropy subtraction. Solid curves plot exact, ideal (imperfection-free) numerics of H_{Ryd} (Equation 3); excellent agreement between data and numerics is found for every atom in the chain. FIG. 14B, Top shows the same data as FIG. 4F, showing single-site entropy of the middle two atoms in the chain, for two different initial states. FIG. 14B, Bottom shows measurements of the many-body state in the Z-basis with the interferometry circuit turned off. Characteristic of the scars from the | [symbol] ₂ [symbol] =|rgrgrgrg [symbol] state, the Rydberg excitation probability on the sublattices exhibits periodic oscillations. In the bottom row, the dark data points are measured in the {|1 [symbol] , |r [symbol] } basis, and the faint data points are measured in the {|0 [symbol] , |1 [symbol] } basis after the coherent mapping sequence. Measurements in both bases agree well with exact numerics (solid lines), which has no free fit parameters and does not account for any experimental imperfections, such as detection infidelity. Moreover, the data indicate the high fidelity of preparation into the | [symbol] [symbol] state by use of local Rydberg π pulses. In plotting, the theory curves and the {|1 [symbol] , |r [symbol] } basis measurement are delayed by 10 ns to account for the fact that the Raman It pulse applied cuts off the final 10 ns of the Rydberg evolution, when measuring in the {|0 [symbol] , |1 [symbol] } basis. FIG. 14C shows numerical simulations of the single-site Renyi entropy on two adjacent sites in the idealized ‘PXP’ model of perfect nearest-neighbor blockade. The system size is 24 atoms with periodic boundary conditions, showing the same out-of-phase oscillations in the entanglement entropy of the two sublattices. FIG. 14D is a diagram of the constrained Hilbert space of the system. The early-time, out-of-phase entropy oscillations of the scars can be understood in this constrained Hilbert space picture, where the scar dynamics are known to take the state from the left end (|rgrgrgrg [symbol] ) to the right end (|grgrgrgr [symbol] ) (dark circles represent |r [symbol] and white circles represent |G [symbol] ). Near these crystalline ends of this constrained Hilbert space, the Rydberg atoms can fluctuate (high entropy), but the ground state atoms are pinned (low entropy). The analysis shows that entanglement between atoms on the same sublattice contributes to the eventual degradation of the revival fidelity of the | [symbol] [symbol] state.

### Formation of Array of Particles Using Optical Tweezers

Optical trapping of neutral atoms is a powerful technique for isolating atoms in vacuum. Atoms are polarizable, and the oscillating electric field of a light beam induces an oscillating electric dipole moment in the atom. The associated energy shift in an atom from the induced dipole, averaged over a light oscillation period, is called the AC Stark shift. Based on the AC Stark shift induced by light that is detuned (i.e., offset in wavelength) from atomic resonance transitions, atoms are trapped at local intensity maxima (for red detuned, that is, longer wavelength trap light), because the atoms are attracted to light below the resonance frequency. The AC Stark shift is proportional to the intensity of the light. Thus, the shape of the intensity field is the shape of an associated atom trap. Optical tweezers utilize this principle by focusing a laser to a micron-scale waist, where individual atoms are trapped at the focus. Two-dimensional (2D) arrays of optical tweezers are generated by, for example, illuminating a spatial light modulator (SLM), which imprints a computer-generated hologram on the wavefront of the laser field. The 2D array of optical tweezers is overlapped with a cloud of laser-cooled atoms in a magneto-optical trap (MOT). The tightly focused optical tweezers operate in a “collisional blockade” regime, in which single atoms are loaded from the MOT, while pairs of atoms are ejected due to light-assisted collisions, ensuring that the tweezers are loaded with at most single atoms, but the loading is probabilistic, such that the trap is loaded with a single atom with a probability of about 50-60%.

To prepare deterministic atom arrays, a real-time feedback procedure identifies the randomly loaded atoms and rearranges them into pre-programmed geometries. Atom rearrangement requires moving atoms in tweezers which can be smoothly steered to minimize heating, by using, for example, acousto-optic deflectors (AODs) to deflect a laser beam by a tunable angle which is controlled by the frequency of an acoustic waveform applied to the AOD crystal. Dynamic tuning of the acoustic frequency translates into smooth motion of an optical tweezer. A multi-frequency acoustic wave creates an array of laser deflections, which, after focusing through a microscope objective, forms an array of optical tweezers with tunable position and amplitude that are both controlled by the acoustic waveform. Atoms are rearranged by using an additional set of dynamically moving tweezers that are overlaid on top of the SLM tweezer array.

### Exemplary Hardware

Optical tweezer arrays constitute a powerful and flexible way to construct large scale systems composed of individual particles. Each optical tweezer traps a single particle, including, but not limited to, individual neutral atoms and molecules for applications in quantum technology. Loading individual particles into such tweezer arrays is a stochastic process, where each tweezer in the system is filled with a single particle with a finite probability p<1, for example p˜0.5 in the case of many neutral atom tweezer implementations. To compensate for this random loading, real-time feedback may be obtained by measuring which tweezers are loaded and then sorting the loaded particles into a programmable geometry. This may be performed by moving one particle at a time, or in parallel.

Parallel sorting may be achieved by using two acousto-optic deflectors (AODs) to generate multiple tweezers that can pick up particles from an existing particle-trapping structure, move them simultaneously, and release them somewhere else. This can include moving particles around within a single trapping structure (e.g., tweezer array) or transporting and sorting particles from one trapping system to another (e.g., between one tweezer array and another type of optical/magnetic trap). This sorting is flexible and allows programmed positioning of each particle. Each movable trap is formed by the AODs and its position is dynamically controlled by the frequency components of the radiofrequency (RF) drive field for the AODs. Since the RF drive of the AODs can be controlled in real time and can include any combination of frequency components, it is possible to generate any grid of traps (such as a line of arbitrarily positioned traps), move the rows or columns of the grid, and add or remove rows and columns of the grid, by changing the number, magnitude, and distribution of the frequency components in the RF drive fields of the AODs.

In an exemplary embodiment, an optical tweezer array is created using a liquid crystal on silicon spatial light modulator (SLM), which can programmatically create flexible arrangements of tweezers. These tweezers are fixed in space for a given experimental sequence and loaded stochastically with individual atoms, such that each tweezer is loaded with probability p˜0.5. A fluorescence image of the loaded atoms is taken, to identify in real-time which tweezers are loaded and which are empty.

After detecting which tweezers are loaded, movable tweezers overlapping the optical tweezer array can dynamically reposition atoms from their starting locations to fill a target arrangement of traps with near-unity filling. The movable tweezers are created with a pair of crossed AODs. These AODs can be used to create a single moveable trap which moves one atom at a time to fill the target arrangement or to move many atoms in parallel.

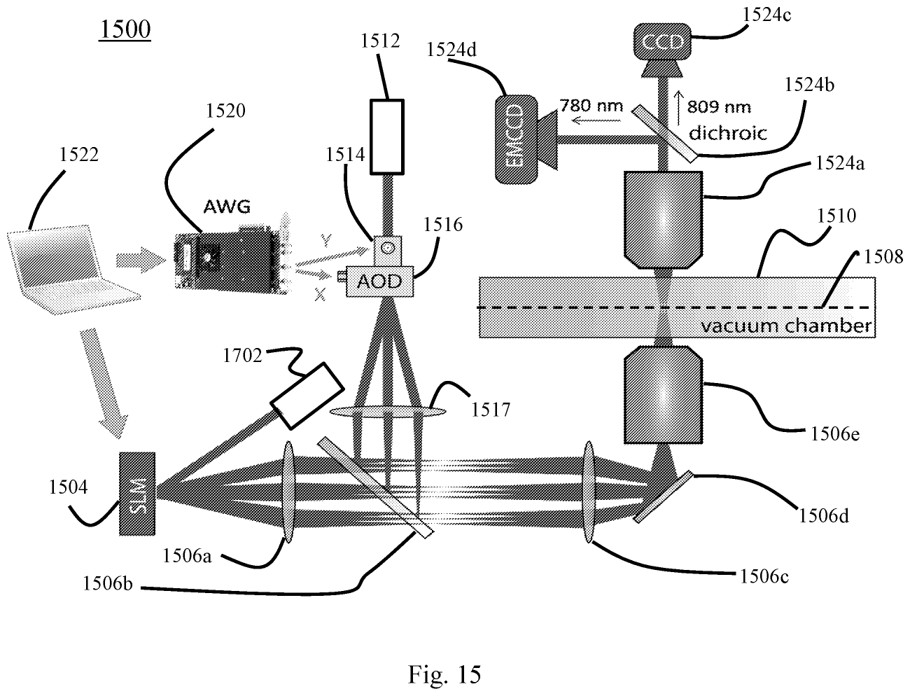

Referring to FIG. 15, a schematic view is provided of an apparatus 1500 for quantum computation according to embodiments of the present disclosure. As shown in FIG. 15, using a beam generated by a light source 1502 (for example, a coherent light source, in some example embodiments—a monochromatic light source), SLM 1504 forms an array of trapping beams (i.e., a tweezer array) which is imaged onto trapping plane 1508 in vacuum chamber 1510 by an optical train that, in the example embodiment shown in FIG. 15, comprises elements 1506a, 1506c, 1506d, and a high numerical aperture (NA) objective 1506e. Other suitable optical trains can be employed, as would be easily recognized by a person of ordinary skill in the art. Using a beam generated by light source 1512 (for example, a coherent light source: in some example embodiments—a monochromatic light source), a pair of AODs 1514 and 1516, having non-parallel directions of acoustic wave propagation (for example, orthogonal directions) creates dynamically movable sorting beams. By using the optical train, such as the one depicted in FIG. 15 (elements 1517, 1506b, 1506c, 1506d, and 1506e), the sorting beams are overlapped with the trapping beams. It is understood that other optical train can be used to achieve the same result. For example, source 1502 and 1512 can be a single source, and the trapping beam and the sorting beam are generated by a beam splitter.

The dynamic movement of the steering beams is accomplished by employing two non-parallel AODs 1514, 1516, arranged in series. In the example embodiment depicted in FIG. 15, one AOD defines the direction of “rows” (“horizontal”—the ‘X’ AOD) and the other AOD defines the direction of “columns” (“vertical”—the ‘Y’ AOD). Each AOD is driven with an arbitrary RF waveform from an arbitrary waveform generator 1520, which is generated in real-time by a computer 1522 which processes the feedback routine after analyzing the image of where atoms are loaded. If each AOD is driven with a single frequency component, then a single steering beam (“AOD trap”) is created in the same plane 1508 as the SLM trap array. The frequency of the X AOD drive determines the horizontal position of the AOD trap, and the frequency of the Y AOD drive determines the vertical position: in this way, a single AOD trap can be steered to overlap with any SLM trap.

In FIG. 15, laser 1502 projects a beam of light onto SLM 1504. SLM 1504 can be controlled by computer 1522 in order to generate a pattern of beams (“trapping beams” or “tweezer array”). The pattern of beams is focused by lens 1506a, passes through mirror 1506b, and is collimates by lens 1506c on mirror 1506d. The reflected light passes through objective 1506e to focus an optical tweezer array in vacuum chamber 1510 on trapping plane 1508. The laser light of the optical tweezer array continues through objective 1524a, and passes through dichroic mirror 1524b to be detected by charge-coupled device (CCD) camera 1524c.

Vacuum chamber 1510 may be illuminated by an additional light source (not pictured). Fluorescence from atoms trapped on the trapping plane also passes through objective 1524a, but is reflected by dichroic mirror 1524b to electron-multiplying CCD (EMCCD) camera 1524d.

In this example, laser 1512 directs a beam of light to AODs 1514, 1516. AODs 1514, 1516 are driven by arbitrary wave generator (AWG) 1520, which is in turn controlled by computer 1522. Crossed AODs 1514, 1516 emit one or more beams as set forth above, which are directed to focusing lens 1517. The beams then enter the same optical train 1506b . . . 1506e as described above with regard to the optical tweezer array, focusing on trapping plane 1508.

It will be appreciated that alternative optical trains may be employed to produce an optical tweezer array suitable for use as set out herein.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method performing a quantum computation, the method comprising:
providing a plurality of neutral atoms, each of the plurality of neutral atoms disposed in a corresponding optical trap;
preparing each of the plurality of neutral atoms in a m_{F}=0 clock state;
entangling a pair of neutral atoms of the plurality of neutral atoms by directing a laser pulse thereto, the laser pulse configured to transition the pair of neutral atoms through a Rydberg state;
adiabatically moving the optical trap corresponding to at least one neutral atom of the pair and applying a Raman pulse to the at least one neutral atom during said moving, thereby moving the neutral atoms of the pair relative to each other without destroying entanglement of the pair.

2. The method of claim 1, wherein the Raman pulse is applied at a midpoint of said moving.

3. The method of claim 1 or 2, wherein the adiabatic movement has a constant jerk.

4. The method of any one of claims 1 to 3, wherein the adiabatic movement has an average speed less than 0.55 μm/μs.

5. The method of any one of claims 1 to 4, further comprising:
moving the optical trap corresponding to the at least one neutral atom to within a blockade radius of a target neutral atom of the plurality of neutral atoms.

6. The method of claim 5, further comprising:
entangling the at least one neutral atom with the target neutral atom.

7. The method of claim 5, further comprising:
applying a gate to the at least one neutral atom and the target neutral atom.

8. The method of any one of claims 1 to 7, wherein the plurality of neutral atoms forms a two-dimensional array.

9. The method of claim 8, wherein the at least one neutral atom and the target neutral atom are non-adjacent within the two-dimensional array prior to said moving.

10. The method of any one of claims 1 to 9, wherein the optical trap corresponding to the at least one neutral atom is generated by directing a beam of light to at least one acousto-optic deflector (AOD) and wherein adiabatically moving the optical trap corresponding to at least one neutral atom comprises varying a drive frequency of the at least one AOD.

11. The method of any one of claims 1 to 10, wherein at least a first subset of the optical traps corresponding to the plurality of neutral atoms is generated by directing a beam of light to a spatial light modulator (SLM).

12. A method of performing a quantum computation, the method comprising:
providing a plurality of neutral atoms, each of the plurality of neutral atoms disposed in a corresponding optical trap:
preparing each of the plurality of neutral atoms in a m_{F}=0 clock state:
entangling a pair of neutral atoms of the plurality of neutral atoms by directing a laser pulse thereto, the laser pulse configured to transition the pair of neutral atoms through a Rydberg state:
adiabatically moving the optical trap corresponding to at least one neutral atom of the pair, thereby moving the neutral atoms of the pair relative to each other without destroying entanglement of the pair:
illuminating a first region, the first region containing therein a first atom of the pair, thereby applying a rotation to the first atom of the pair:
adiabatically moving the optical trap corresponding to the first atom of the pair out of the first region;
adiabatically moving the optical trap corresponding to a second atom of the pair into the first region; and
illuminating the first region, thereby applying a rotation to the second atom of the pair.

13. The method of claim 12, further comprising:
applying a Raman pulse to the at least one neutral atom during said moving.

14. The method of claim 13, wherein the Raman pulse is applied at a midpoint of said moving.

15. The method of any one of claims 12 to 14, wherein the adiabatic movement has a constant jerk.

16. The method of any one of claims 12 to 15, wherein the adiabatic movement has an average speed less than 0.55 μm/μs.

17. The method of any one of claims 12 to 16, wherein the plurality of neutral atoms forms a two-dimensional array.

18. The method of any one of claims 12 to 17, wherein the optical trap corresponding to the at least one neutral atom is generated by directing a beam of light to at least one acousto-optic deflector (AOD) and wherein adiabatically moving the optical trap corresponding to at least one neutral atom comprises varying a drive frequency of the at least one AOD.

19. The method of any one of claims 12 to 18, wherein at least a first subset of the optical traps corresponding to the plurality of neutral atoms is generated by directing a beam of light to a spatial light modulator (SLM).

20. A method of performing a quantum computation, the method comprising:
providing a plurality of neutral atoms, each of the plurality of neutral atoms disposed in a corresponding optical trap, the plurality of neutral atoms comprising a first subset and a second subset, each neutral atom of the first subset being placed within a blockade radius of a first corresponding neutral atom of the second subset, thereby forming a first plurality of pairs;
preparing each of the plurality of neutral atoms in a m_{F}=0 clock state;
applying a first gate to each of the first plurality of pairs;
adiabatically moving the optical traps corresponding to the first subset such that each neutral atom of the first subset is within the blockade radius of a second corresponding neutral atom of the second subset, thereby forming a second plurality of pairs, and applying a Raman pulse to the first subset during said moving;
applying a second gate to each of the second plurality of pairs.

21. The method of claim 20, wherein the first and/or second gate is a CZ gate.

22. The method of claim 20 or 21, further comprising:
adiabatically moving the optical traps corresponding to the first subset to an imaging region not including the second subset;
illuminating the imaging region to measure a state of the first subset.

23. The method of one of claims 20 to 22, wherein the optical traps corresponding to the first subset are moved simultaneously.

24. The method of any one of claims 20 to 23, wherein the Raman pulse is applied at a midpoint of said moving.

25. The method of any one of claims 20 to 24, wherein the adiabatic movement has a constant jerk.

26. The method of any one of claims 20 to 25, wherein the adiabatic movement has an average speed less than 0.55 μm/μs.

27. The method of any one of claims 20 to 26, wherein the plurality of neutral atoms forms a two-dimensional array.

28. The method of any one of claims 20 to 27, wherein the optical trap corresponding to the at least one neutral atom is generated by directing a beam of light to at least one acousto-optic deflector (AOD) and wherein adiabatically moving the optical trap corresponding to at least one neutral atom comprises varying a drive frequency of the at least one AOD.

29. The method of any one of claims 20 to 28, wherein at least a first subset of the optical traps corresponding to the plurality of neutral atoms is generated by directing a beam of light to a spatial light modulator (SLM).

30. A method of performing a quantum computation, the method comprising:
providing a plurality of neutral atoms, each of the plurality of neutral atoms disposed in a corresponding optical trap;
preparing each of the plurality of neutral atoms in a m_{F}=0 clock state;
adiabatically moving the plurality of neutral atoms between a first arrangement and a second arrangement different from the first arrangement, wherein the first array configuration comprises at least one pair of neutral atoms within a blockade radius of each other;
applying a gate to the at least one pair of neutral atoms when in the first arrangement;
evolving the plurality of neutral atoms according to a first Hamiltonian when in the second arrangement.

31. The method of claim 30, further comprising:
applying a Raman pulse to the at least one neutral atom during said moving.

32. The method of claim 31, wherein the Raman pulse is applied at a midpoint of said moving.

33. The method of any one of claims 30 to 32, wherein the adiabatic movement has a constant jerk.

34. The method of any one of claims 30 to 33, wherein the adiabatic movement has an average speed less than 0.55 μm/μs.

35. The method of any one of claims 30 to 34, wherein the plurality of neutral atoms forms a two-dimensional array.

36. The method of any one of claims 30 to 35, wherein the optical trap corresponding to the at least one neutral atom is generated by directing a beam of light to at least one acousto-optic deflector (AOD) and wherein adiabatically moving the optical trap corresponding to at least one neutral atom comprises varying a drive frequency of the at least one AOD.

37. The method of any one of claims 30 to 36, wherein at least a first subset of the optical traps corresponding to the plurality of neutral atoms is generated by directing a beam of light to a spatial light modulator (SLM).

38. A quantum computer, comprising:
a plurality of optical traps;
a plurality of neutral atoms, each of the plurality of neutral atoms disposed in a corresponding one of the plurality of optical traps;
at least one laser, the at least one laser configured to
prepare each of the plurality of neutral atoms in a m_{F}=0 clock state, and
entangle a pair of neutral atoms of the plurality of neutral atoms by transitioning the pair of neutral atoms through a Rydberg state;
wherein
the quantum computer is configured to adiabatically move the optical trap corresponding to at least one neutral atom of the pair and apply a Raman pulse to the at least one neutral atom during said moving, thereby moving the neutral atoms of the pair relative to each other without destroying entanglement of the pair.

39. A quantum computer, comprising:
a plurality of optical traps;
a plurality of neutral atoms comprising a first subset and a second subset, each of the plurality of neutral atoms disposed in a corresponding one of the plurality of optical traps, each neutral atom of the first subset being placed within a blockade radius of a first corresponding neutral atom of the second subset, thereby forming a first plurality of pairs;
at least one laser, the at least one laser configured to prepare each of the plurality of neutral atoms in a m_{F}=0 clock state, wherein the quantum computer is configured to:
apply a gate to each of the first plurality of pairs;
adiabatically move the optical traps corresponding to the first subset such that each neutral atom of the first subset is within the blockade radius of a second corresponding neutral atom of the second subset, thereby forming a second plurality of pairs;
apply a Raman pulse to the first subset during said moving; and
apply a gate to each of the second plurality of pairs.
